(19) United States
(12) Patent Application Publication
(10) Pub. No.: US 2026/0080585 A1
(43) Pub. Date: Mar. 19, 2026

(54) ELECTRONIC DEVICE, METHOD, AND COMPUTER-READABLE STORAGE MEDIUM FOR CACHING IMAGE

(71) Applicant: SAMSUNG ELECTRONICS CO., LTD., Suwon-si (KR)

(72) Inventors: Joonhyun Choi, Suwon-si (KR); Wonguen Cho, Suwon-si (KR); Boyoung Kim, Suwon-si (KR); Taeyun Kim, Suwon-si (KR); Jaesik Sohn, Suwon-si (KR); Hoseol Jeon, Suwon-si (KR)

(73) Assignee: SAMSUNG ELECTRONICS CO., LTD., Suwon-si (KR)

(21) Appl. No.: 19/233,721

(22) Filed: Jun. 10, 2025

Related U.S. Application Data
(63) Continuation of application No. PCT/KR2025/007294, filed on May 28, 2025.

(30) Foreign Application Priority Data
Sep. 13, 2024 (KR) 10-2024-0125774
Oct. 11, 2024 (KR) 10-2024-0139001

(51) Int. Cl. G06T 11/20; G06T 1/60; G06T 7/62; G06V 10/25

(52) U.S. Cl. CPC G06T 11/23; G06T 1/60; G06T 7/62; G06V 10/25

(57) ABSTRACT

An electronic device includes at least one processor comprising processing circuitry, a display, and memory, storing one or more programs configured to be executed by the at least one processor individually or collectively, comprising one or more storage media, wherein the one or more programs includes instructions to cause the electronic device to, identify a stroke including a plurality of points, based on rendering the stroke, display, via the display, the stroke, using the points, identify a bounding box surrounding the stroke and location information of the bounding box, based on at least one of a number of the points, a size of the bounding box, or computation amount required for rendering the stroke, determine whether an image, obtained using the bounding box, is cacheable, and based on a determination that the image is cacheable, cache the image and the location information of the bounding box.

### CROSS-REFERENCE TO RELATED APPLICATIONS

This application is a continuation of International Application No. PCT/KR2025/007294 designating the United States, filed on May 28, 2025, in the Korean Intellectual Property Receiving Office and claiming priority to Korean Patent Application Nos. 10-2024-0125774, filed on Sep. 13, 2024, and 10-2024-0139001, filed Oct. 11, 2024, in the Korean Intellectual Property Office, the disclosures of each of which are incorporated by reference herein in their entireties.

### BACKGROUND

### 1. Field

The disclosure relates to an electronic device, a method, and a computer-readable storage medium for caching an image.

### 2. Description of Related Art

An electronic device may identify a handwriting input indicated by strokes drawn by a user. For example, the user may draw strokes indicating the handwriting by moving a finger, a stylus, and/or a digitizer contacted on a display of the electronic device, or moving a pointing device (e.g., a mouse) connected to the electronic device. The electronic device may display the strokes drawn by the user based on the handwriting input on the display.

The above-described information may be provided as a related art for the purpose of helping understanding of the present disclosure. No argument or decision is made as to whether any of the above description may be applied as a prior art related to the present disclosure.

### SUMMARY

According to an aspect of the disclosure, an electronic device is described. The electronic device may comprise at least one processor comprising processing circuitry, a display, and memory, storing one or more programs configured to be executed by the at least one processor individually and/or collectively, comprising one or more storage media. The one or more programs may include instructions to cause the electronic device to, based on a handwriting input received via the display, identify a stroke including a plurality of points. The one or more programs may include instructions to cause the electronic device to, based on rendering the stroke, display, via the display, the stroke. The one or more programs may include instructions to cause the electronic device to identify, using the points, a bounding box surrounding the stroke and location information of the bounding box. The one or more programs may include instructions to cause the electronic device to, based on at least one of a number of the points, a size of the bounding box, and/or computation amount consumed for rendering the stroke, determine whether an image, obtained using the bounding box, is cacheable. The one or more programs may include instructions to cause the electronic device to, based on a determination that the image is cacheable, cache the image and the location information of the bounding box.

According to an aspect of the disclosure, a method is described. The method may be executed in an electronic device comprising a display. The method may comprise, based on a handwriting input received via the display, identifying a stroke including a plurality of points. The method may comprise, based on rendering the stroke, displaying, via the display, the stroke. The method may comprise identifying, using the points, a bounding box surrounding the stroke and location information of the bounding box. The method may comprise, based on at least one of a number of the points, a size of the bounding box, and/or computation amount consumed for rendering the stroke, determining whether an image, obtained using the bounding box, is cacheable. The method may comprise, based on a determination that the image is cacheable, caching the image and the location information of the bounding box.

According to an aspect of the disclosure, a non-transitory computer-readable storage medium is described. The non-transitory computer-readable storage medium may store one or more programs. The one or more programs, when executed by an electronic device including a display, may include instructions to cause the electronic device to, based on a handwriting input received via the display, identify a stroke including a plurality of points. The one or more programs, when executed by the electronic device, may include instructions to cause the electronic device to, based on rendering the stroke, display, via the display, the stroke. The one or more programs, when executed by the electronic device, may include instructions to cause the electronic device to identify, using the points, a bounding box surrounding the stroke and location information of the bounding box. The one or more programs, when executed by the electronic device, may include instructions to cause the electronic device to, based on at least one of a number of the points, a size of the bounding box, and/or computation amount consumed for rendering the stroke, determine whether an image, obtained using the bounding box, is cacheable. The one or more programs, when executed by the electronic device, may include instructions to cause the electronic device to, based on a determination that the image is cacheable, cache the image and the location information of the bounding box.

### BRIEF DESCRIPTION OF DRAWINGS

FIG. 1A illustrates an example of re-rendering (or re-draw) strokes based on an input for removing a stroke.

FIG. 1B illustrates an example of an axis-aligned bounding box surrounding a stroke.

FIG. 2 is a simplified block diagram of an exemplary electronic device.

FIG. 3 is a flowchart illustrating exemplary operations of an electronic device for identifying a bounding box surrounding a stroke based on a user input.

FIG. 4 illustrates an example of displaying a stroke based on rendering the stroke.

FIG. 5 illustrates an example of identifying a bounding box surrounding a stroke and location information of the bounding box.

FIG. 6 is a flowchart illustrating exemplary operations of an electronic device for determining whether an image, obtained using a bounding box, is cacheable.

FIG. 7 is a flowchart illustrating exemplary operations of an electronic device for determining whether an image is cacheable based on the number of points included in a stroke.

FIG. 8 is a flowchart illustrating exemplary operations of an electronic device for determining whether an image is cacheable based on a size of a bounding box and/or computation amount required for rendering a stroke.

FIG. 9 illustrates an example of determining whether an image is cacheable based on the number of points included in a stroke and/or a size of a bounding box.

FIG. 10 illustrates an example of computation amount according to a pen type of a stroke.

FIG. 11 is a flowchart illustrating exemplary operations of an electronic device for determining whether cached images are mergeable.

FIG. 12A illustrates an example of merging images and location information of bounding boxes according to a level.

FIG. 12B illustrates an example of cached images in a caching block.

FIG. 13 is a flowchart illustrating exemplary operations of an electronic device for separating a merged file into images and location information of bounding boxes.

FIG. 14 is a flowchart illustrating exemplary operations of an electronic device for removing a stroke.

FIG. 15 illustrates an example of removing a stroke according to an embodiment.

FIG. 16 illustrates exemplary configurations of an electronic device according to an embodiment.

FIG. 17 is a block diagram of an electronic device in the network environment according to various embodiments.

### DETAILED DESCRIPTION

Hereinafter, embodiments of the present disclosure will be described in detail with reference to drawings so that those having ordinary knowledge in the art to which the present disclosure belongs may easily implement it. However, the present disclosure may be implemented in several different forms and is not limited to the embodiment described herein. With respect to a description of the drawing, the same or a similar reference numeral may be used for the same or a similar component. In addition, in the drawing and the related description, the description of a well-known function and a configuration may be omitted for clarity and brevity.

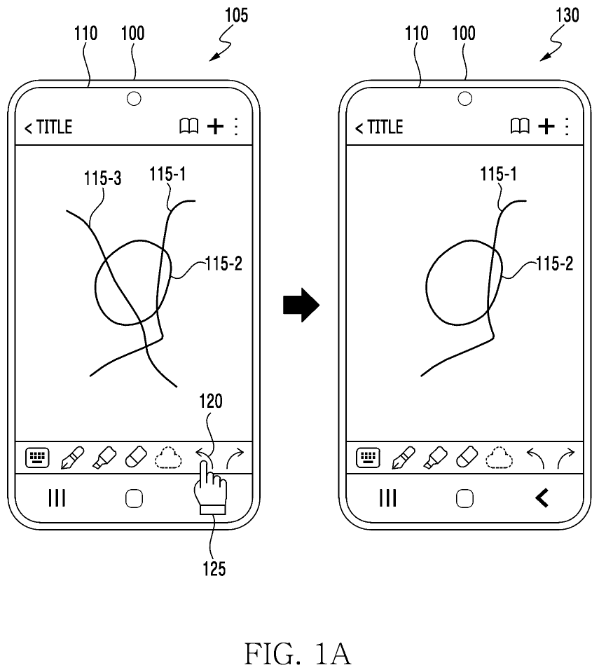

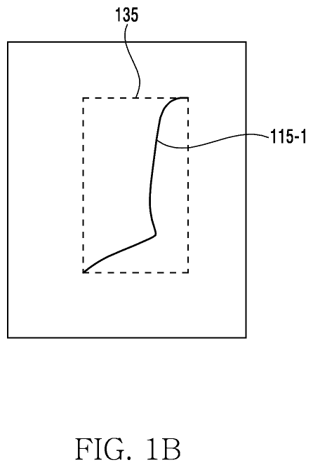

FIG. 1A illustrates an example of re-rendering (or re-draw) strokes based on an input for removing a stroke.

Referring to FIG. 1A, an electronic device 100 may be described as a device capable of receiving a user input. For example, the electronic device 100 may be one of various types of mobile devices, such as smartphones (e.g., a bar-type smartphone, a foldable-type smartphone, or a rollable-type smartphone) having various form factors, a tablet, a wearable device, a cellular phone, a personal computer (PC) (e.g., a laptop and/or a desktop), and/or other similar computing devices including circuits (or circuitry) for providing an operation for receiving the user input.

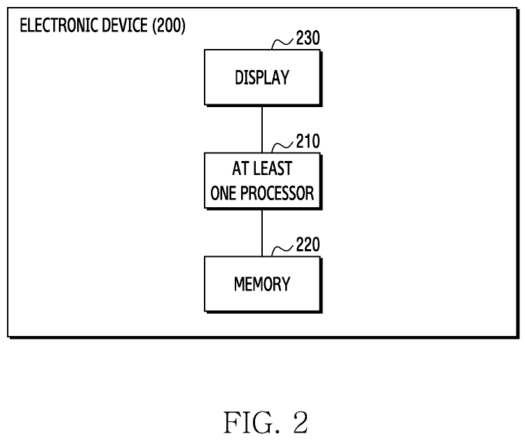

The electronic device 100 may include a display 110 (e.g., a display 230 of FIG. 2). In an example state 105, the electronic device 100 may receive a user input via the display 110. For example, the user input may include a handwriting input. The electronic device 100 may receive the user input based on a fingertip, a stylus, a digitizer contacted on the display 110, and/or a pointing device such as a mouse for adjusting a location of a cursor. The electronic device 100 may identify strokes 115-1, 115-2, and 115-3 based on the user input. The electronic device 100 may display the strokes 115-1, 115-2, and 115-3 via the display 110 based on rendering the strokes 115-1, 115-2, and 115-3. For example, the electronic device 100 may display the strokes 115-1, 115-2, and 115-3 on the display 110. According to an embodiment, rendering the strokes 115-1, 115-2, and 115-3 may include generating or redrawing the strokes 115-1, 115-2, and 115-3 based on the user input.

The electronic device 100 may receive an input 125 for removing one of the strokes 115-1, 115-2, and 115-3 displayed on the display 110. For example, the electronic device 100 may receive an input 125 for removing the last displayed stroke 115-3 while displaying the strokes 115-1, 115-2, and 115-3. The input 125 may be an undo input, but the disclosure is not limited thereto. The stroke 115-1, the stroke 115-2, and the stroke 115-3 may be described as sequentially identified (or displayed) strokes. The input 125 may include a touch input for an executable object 120 displayed via the display 110. The input 125 may be received via the display 110 (e.g., a touch screen).

The electronic device 100 may switch from the state 105 to a state 130 based on receiving the input 125. In the state 130, the electronic device 100 may re-render (or redraw) the stroke 115-1 and the stroke 115-2 without the stroke 115-3, thus removing the stroke 115-3 based on the input 125. For example, the electronic device 100 may maintain displaying the stroke 115-1 and the stroke 115-2, and cease displaying (or refrain from displaying, or do not display) the stroke 115-3, based on re-rendering the stroke 115-1 and the stroke 115-2. Whenever the input 125 for removing the stroke 115-3 is received, re-rendering the strokes 115-1 and 115-2 before the stroke 115-3 may cause deterioration in performance of the electronic device 100 by increasing computation amount of the electronic device 100 required for rendering the strokes 115-1 and 115-2.

In order to solve this deterioration in the performance of the electronic device 100, the electronic device 100 may refrain from re-rendering the strokes 115-1 and 115-2 by caching an image (or texture) including the rendered strokes 115-1 and 115-2. In the present disclosure, the “texture” may be referred as a two-dimensional (2D) image or bitmap-like representation stored in memory (e.g., GPU memory) that is used to cache a visual result of rendered stroke. The texture may be captured as a final rendered result of strokes displayed at a given moment, and may be used to avoid repeatedly rendering each stroke during redraw operations. According to an embodiment, since the electronic device 100 minimizes rendering the strokes 115-1 and 115-2 by caching the image (or the texture) including the rendered strokes 115-1 and 115-2, the degradation of the performance of the electronic device 100 may be reduced. The electronic device 100 may use a bounding box surrounding the strokes 115-1 and 115-2 to obtain the image including the rendered strokes 115-1 and 115-2. The bounding box surrounding the strokes 115-1 is illustrated in a description of FIG. 1B.

FIG. 1B illustrates an example of an axis-aligned bounding box surrounding a stroke.

Referring to FIG. 1B, the electronic device 100 may identify bounding box 135 surrounding the stroke 115-1 based on identifying the stroke 115-1 corresponding to the user input. The bounding box 135 may be an axis-aligned bounding box. The bounding box 135 may have a side parallel to a base axis of the display 110. The electronic device 100 may identify the axis-aligned bounding box 135 based on a maximum value and a minimum value of a coordinate value of a point included in the stroke 115-1. The axis-aligned bounding box 135 may be obtained based on a relatively uncomplicated computation, but may have a relatively large size. The axis-aligned bounding box 135 may include a relatively large area not occupied by the stroke 115-1 in the bounding box 135 by having a relatively large size.

The electronic device 100 may obtain the image (or the texture) including the stroke 115-1 by cropping the bounding box 135. For example, since the bounding box 135 has the relatively large size, a relatively large capacity (e.g., large memory capacity) may be required to cache the image obtained using the bounding box 135 (or by cropping the bounding box 135). Caching images obtained using a plurality of axis-aligned bounding boxes 135 may cause a problem of memory shortage of the electronic device 100.

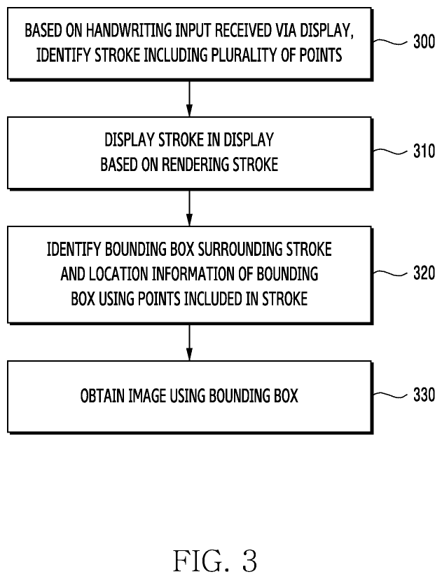

In order to solve this problem, it may be required that the image including the stroke 115-1 has a relatively small size. According to an embodiment, a method for reducing the size of the image including the stroke 115-1 may be provided. For example, the electronic device 100 may use an oriented bounding box rotated with respect to the base axis of the display 110 to obtain the image including the stroke 115-1 having the relatively small size. According to an embodiment, the electronic device 100 may detect a minimum area capable of storing the stroke 115-1 by analyzing the stroke 115-1. The electronic device 100 may store transform information of the oriented bounding box having the minimum area capable of storing the stroke 115-1. According to an embodiment, the electronic device 100 may perform operations as illustrated in FIGS. 3 to 15, to cache an image surrounding the stroke 115-1 obtained using the oriented bounding box. The electronic device 100 may include components for performing the operations. The components may be exemplified in the description of FIG. 2.

FIG. 2 is a simplified block diagram of an exemplary electronic device.

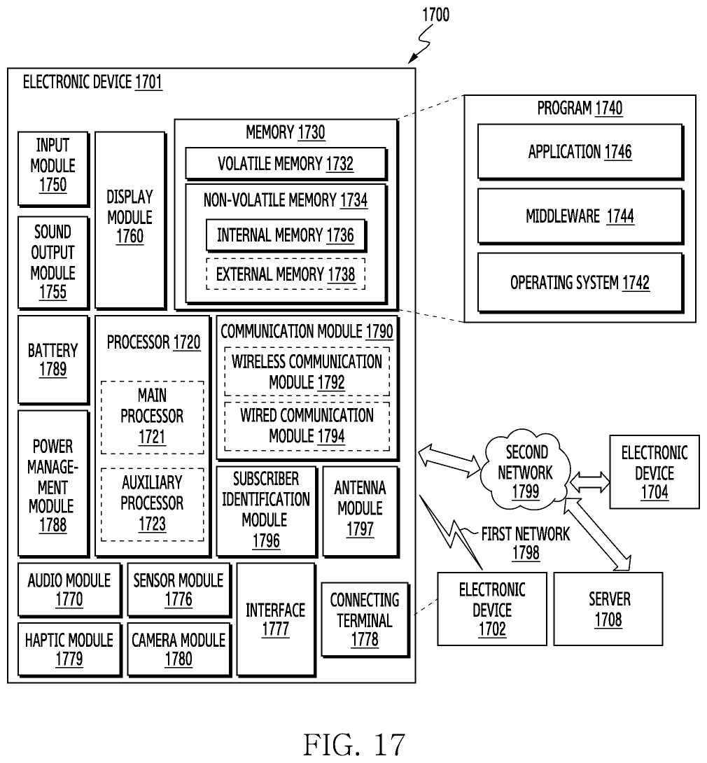

Referring to FIG. 2, according to an embodiment, an electronic device 100 may be one of various types of mobile devices, such as smartphones (e.g., a bar-type smartphone, a foldable-type smartphone, or a rollable-type smartphone), a tablet, a wearable device, a cellular phone, a personal computer (PC) (e.g., a laptop and/or a desktop) having various form factors, and/or other similar computing devices. For example, the electronic device 200 may include the electronic device 100 of FIG. 1A, or may correspond to the electronic device 100 of FIG. 1A. For example, the electronic device 200 may include at least a portion of an electronic device 1701 of FIG. 17, or may correspond to at least a portion of the electronic device 1701 of FIG. 17. For example, the electronic device 200 may include at least one processor 210, memory 220, and a display 230.

According to an embodiment, the at least one processor 210 may include processing circuitry. For example, the at least one processor 210 may include a central processing unit (CPU) (e.g., including the processing circuitry). For example, the at least one processor 210 may include a graphic processing unit (GPU) (e.g., including the processing circuitry) and/or a neural processing unit (NPU) (e.g., including the processing circuitry). For example, the at least one processor 210 may be described as an application processor. For example, the at least one processor 210 may be configured to control the memory 220 and the display 230. The at least one processor 210 may be configured to execute instructions stored in the memory 220 individually or collectively to cause the electronic device 200 to perform at least a portion of the operations exemplified in a description of FIG. 1A and FIG. 1B. The at least one processor 210 may be configured to execute instructions stored in the memory 220 to cause the electronic device 200 to perform at least a portion of operations exemplified in a description of FIGS. 3 to 15.

According to one or more embodiments of the disclosure, the term “processor” may include various processing circuitry including at least one processor, and one or more of the at least one processor may be configured to perform various functions described below individually and/or collectively in a distributed manner. As used below, in case that “a processor”, “at least one processor”, and “one or more processors” are described as configured to perform various functions, these terms, for example, cover situations in which, without limitation, a processor performs a portion of cited functions, and in which another processor (other processors) performs another portion of the cited functions, and also situations in which a processor may perform all of the cited functions. Additionally, the at least one processor may include a combination of processors performing various functions listed/initiated, for example, in the distributed manner. The at least one processor may execute program instructions to achieve or perform various functions.

According to an embodiment, the memory 220 may include one or more storage mediums. For example, the memory 220 may store various data used by at least one component (e.g., the at least one processor 210 and/or the display 230) of the electronic device 200. For example, the data may include input data or output data for software and a command related therewith. The memory 220 may include volatile memory or non-volatile memory. The volatile memory may be used to cache an image, location information of a bounding box, and/or a file.

According to an embodiment, the display 230 may include a sensor configured to sense or obtain an input by a user. For example, the sensor may include, but is not limited to, a touch sensor configured to (or set to) detect a touch, or a pressure sensor configured to (or set to) measure strength of a force generated by the touch. For example, the display 230 may be configured to display visual information (e.g., a stroke). For example, the display 230 may be configured to receive a user input. For example, the display 230 supporting a touch function may be referred to as a touch screen. The display 230 may further include a structure capable of detecting an input using a stylus pen in a manner such as an electro-magnetic resonance (EMR) or an active electrostatic solution (AES). For example, the user input may be performed using the stylus pen.

The electronic device 200 exemplified in the description of FIG. 2 may execute at least a portion of operations exemplified in the description of FIGS. 3 to 15. For example, the operations exemplified in the description of FIGS. 3 to 15 may be caused by (or in) the electronic device 200 according to control of the at least one processor 210.

FIG. 3 is a flowchart illustrating exemplary operations of an electronic device for identifying a bounding box surrounding a stroke based on a user input.

Referring to FIG. 3, according to an embodiment, in an operation 300, the method may include identifying a stroke based on a user input. For example, the at least one processor 210 may receive the user input via a display 230, but the disclosure is not limited thereto. For example, the user input may include a handwriting input. For example, the user input may be received based on a fingertip, a stylus, a digitizer contacted on the display 230, and/or a pointing device such as a mouse for adjusting a location of a cursor. For example, the user input may include a user gesture drawing the stroke using the fingertip, the stylus, the digitizer contacted on the display 230, and/or the pointing device such as the mouse for adjusting the location of the cursor.

According to an embodiment, the at least one processor 210 may identify the stroke based on the user input. The stroke may correspond to a trajectory and/or a path dragged by the fingertip, the stylus, and/or the digitizer while the fingertip, the stylus, and/or the digitizer are contacted on the display 230. However, the disclosure is not limited thereto, and as such, according to an embodiment, the stroke may correspond to a trajectory and/or a path of the cursor and/or a mouse pointer moved in the display 230 by the pointing device such as the mouse for adjusting the location of the cursor.

According to an embodiment, the stroke may include a plurality of points. The plurality of points may be distributed on the stroke. For example, the plurality of points included in the stroke may have a relatively higher density in a curved portion of the stroke than a straight portion of the stroke. The at least one processor 210 may obtain a list (or a collection) of the plurality of points included in the stroke. The plurality of points included in the stroke may be used to identify the bounding box surrounding the stroke, and/or used to render (or redraw) the stroke.

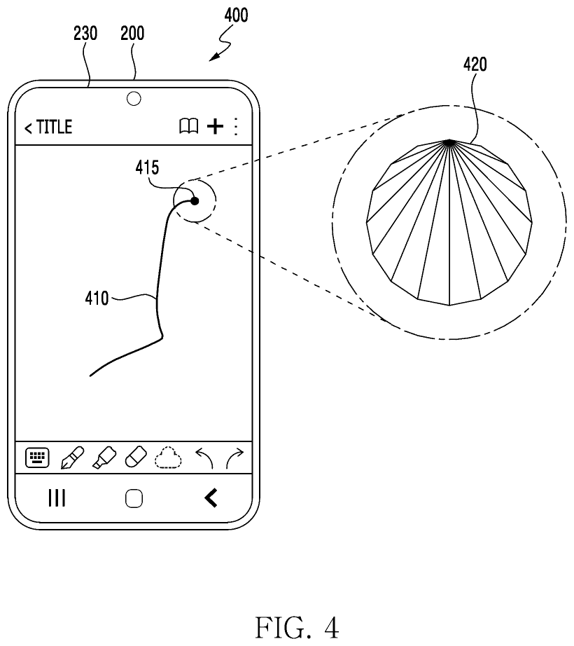

According to an embodiment, in an operation 310, the method may include displaying the stroke on display 230. For example, the at least one processor 210 may render (or redraw) the stroke. For example, the at least one processor 210 may generate circle meshes by rendering each of the plurality of points included in the stroke. For example, the at least one processor 210 may display the stroke via the display 230 using the circle meshes based on rendering the stroke. The at least one processor 210 may display the stroke by rendering the stroke so that the user looks like writing (or drawing) the stroke using an actual pen. According to an embodiment, displaying the stroke based on rendering the stroke is exemplified in the description of FIG. 4.

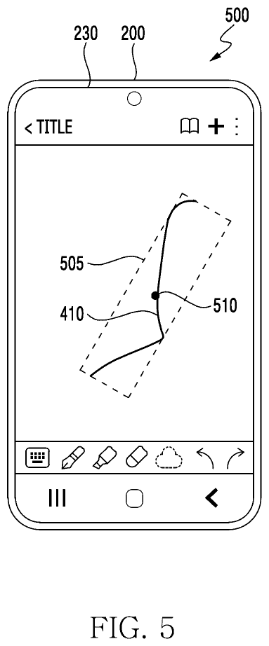

According to an embodiment, in an operation 320, the method may include identifying a bounding box surrounding the stroke. For example, the at least one processor 210 may identify the bounding box (e.g., a bounding box 505 of FIG. 5) surrounding the stroke using points included in the stroke. For example, the bounding box surrounding the stroke may be described as an oriented bounding box rotated with respect to a basis axis of the display 230. In some example cases, the bounding box may be referred to as a boundary surrounding the stroke. The bounding box surrounding the stroke may have a size smaller than an axis-aligned bounding box surrounding the stroke and parallel to the base axis of the display 230 as the bounding box surrounding the stroke is rotated with respect to the base axis of the display 230.

According to an embodiment, the at least one processor 210 may identify location information of the bounding box surrounding the stroke. For example, the location information of the bounding box may include a coordinate of a center point of the bounding box and orientation of the bounding box. The orientation of the bounding box may indicate the degree to which the bounding box is rotated with respect to the base axis of the display 230. The location information of the bounding box may be used to display the stroke again on the display 230. According to an embodiment, identifying the bounding box and the location information of the bounding box is exemplified in a description of FIG. 5.

According to an embodiment, in an operation 330, the method may include obtaining an image using the bounding box. For example, the at least one processor 210 may obtain an image (or texture) including the stroke using the bounding box. According to an embodiment, the at least one processor 210 may identify only information on width of the bounding box and height of the bounding box based on the image obtained using the bounding box, and as such, the location information of the bounding box may be cached in conjunction with the image. The at least one processor 210 may obtain a bounding box-shaped image having sides corresponding to sides of the bounding box by cropping the bounding box. For example, the oriented bounding box may have a relatively smaller size than the axis-aligned bounding box, and as such, a capacity of a relatively small volatile memory (e.g., random access memory (RAM) or a GPU memory buffer) may be required to cache the image obtained using the oriented bounding box.

FIG. 4 illustrates an example of displaying a stroke based on rendering the stroke.

Referring to FIG. 4, according to an embodiment, a state 400 may be described as a state in which a user input is received. In the state 400, the at least one processor 210 may identify a stroke 410 including a plurality of points (e.g., a point 415) based on a user input received via a display 230. The at least one processor 210 may display the stroke 410 on the display 230 based on rendering the stroke 410.

According to an embodiment, the at least one processor 210 may identify an intermediate point list of the plurality of points (e.g., the point 415) included in the stroke 410. The at least one processor 210 may generate circle meshes (e.g., a circle mesh 420) by rendering each of the plurality of points (e.g., the point 415) included in the stroke 410. The at least one processor 210 may obtain a vertex point list of the plurality of points by applying the circle meshes (e.g., the circle mesh 420) to each of the plurality of points (e.g., the point 415). The at least one processor 210 may apply an angle tip to a curve configuring a corner of the stroke 410 by using the vertex point list of the plurality of points. Applying the angle tip may be described by increasing the number of vertex points included in the stroke in order for the curve that form the corner of the stroke to be seen naturally (or smoothly). The at least one processor 210 may display the stroke 410 via the display 230 so that the user looks like writing (or drawing) the stroke using an actual pen based on rendering the stroke 410.

According to an embodiment, the at least one processor 210 may, based on rendering the stroke 410, identify computation amount required for rendering the stroke 410. For example, the computation amount may indicate or correspond to an amount of resource (e.g., power, processing elements, memory, etc. ,) to render the stroke 410. For example, the computation amount required for rendering the stroke 410 may be referred to as a render cost. The computation amount required for rendering the stroke 410 may be determined according to a pen type, a length of the stroke 410, and/or resolution of the stroke 410. For example, the computation amount required for rendering the stroke 410 may be used to determine whether to cache an image obtained using a bounding box (or obtained by cropping a bounding box).

According to an embodiment, displaying the stroke 410 by re-rendering the stroke 410 for editing (e.g., undo, redo, and/or surface change) strokes may deteriorate performance of an electronic device 200 by increasing the computation amount of the electronic device 200. The at least one processor 210 may cache an image including the stroke 410 to refrain from re-rendering the stroke 410 for editing the strokes. In order to obtain the image including the stroke 410, identifying a bounding box surrounding the stroke 410 is exemplified in a description of FIG. 5.

FIG. 5 illustrates an example of identifying a bounding box surrounding a stroke and location information of the bounding box.

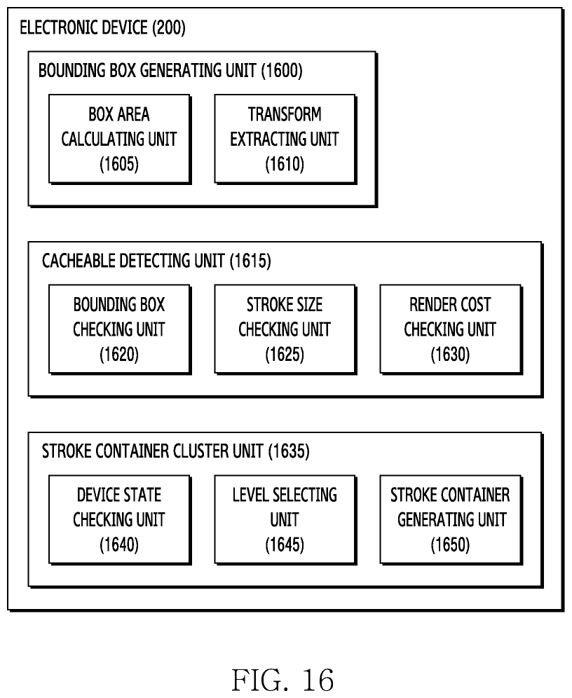

Referring to FIG. 5, according to an embodiment, a state 500 may be described as a state in which a stroke 410 including a plurality of points is identified based on a user input received via a display 230. In the state 500, the at least one processor 210 (e.g., a bounding box generating unit 1600 of FIG. 16) may identify an eigen vector and an eigen value of the plurality of points using the plurality of points included in the stroke 410. The at least one processor 210 (e.g., the bounding box generating unit 1600) may identify, using the eigen vector and the eigen value of the plurality of points, a bounding box 505 surrounding the stroke 410 and rotated with respect to a base axis of the display 230. The bounding box 505 rotated with respect to the base axis of the display 230 may be described as an oriented bounding box. The oriented bounding box 505 may have a size smaller than an axis-aligned bounding box surrounding the stroke 410 (see, for example, an axis-aligned bounding box in FIG. 2). The at least one processor 210 (e.g., the bounding box generating unit 1600) may detect the bounding box 505 surrounding the stroke 410. For example, the at least one processor 210 may detect the bounding box 505 surrounding the stroke 410 having a minimum area.

According to an embodiment, the at least one processor 210 (e.g., a transform extracting unit 1610 of FIG. 16) may identify location information of the bounding box 505. For example, the location information of the bounding box 505 may be referred to as transform information of the bounding box 505. For example, the location information of the bounding box 505 may include a center point 510 of the bounding box 505. The center point 510 of the bounding box 505 may be defined as an x value and a y value on a two-dimensional coordinate plane on the display 230. The center point 510 of the bounding box 505 may be referred to as a center position. For example, the location information of the bounding box 505 may include orientation (or rotation) of the bounding box 505. The orientation of the bounding box 505 may indicate a degree (or an angle) to which the bounding box 505 is rotated with respect to the base axis of the display 230.

According to an embodiment, the location information of the bounding box 505 may be used to retrieve an image obtained using the bounding box 505 to display the stroke 410 again. The at least one processor 210 (e.g., the transform extracting unit 1610) may identify a location to display the image obtained using the bounding box 505 on the display 230 based on the location information of the bounding box 505. The at least one processor 210 (e.g., the transform extracting unit 1610) may display the image obtained using the bounding box 505 by rotating the image with respect to the base axis of the display using the orientation of the bounding box 505 on the center point 510 of the bounding box 505. The at least one processor 210 (e.g., the transform extracting unit 1610) may convert the location information and the orientation of the bounding box 505 into a matrix (e.g., a float 16 array) and store as conversion information. The at least one processor 210 (e.g., the transform extracting unit 1610) may generate a basic element capable of performing cache rendering used in the present invention via area information of the bounding box 505 and conversion information of the bounding box 505.

According to an embodiment, the at least one processor 210 may obtain an image including the stroke 410 using the bounding box 505. The image including the stroke 410 may have sides corresponding to sides of the bounding box 505 by cropping the bounding box 505. As the image including the stroke 410 is cached in a state not being rotated with respect to the base axis of the display 230, the location information of the bounding box 505 may be cached together to retrieve the image including the stroke 410.

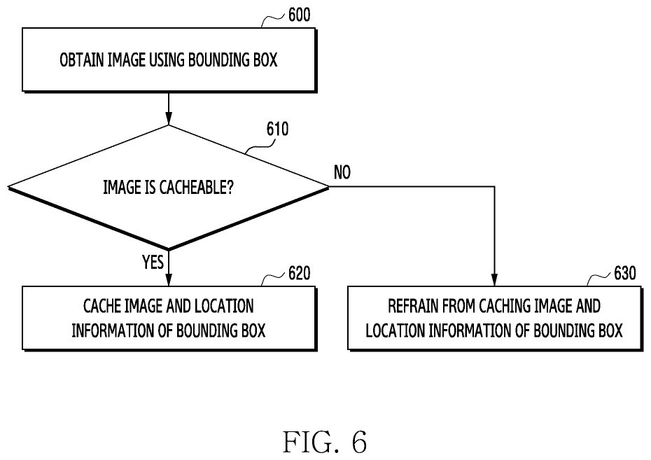

According to an embodiment, the at least one processor 210 may identify a size of the bounding box 505. A capacity required for the image obtained using the bounding box 505 to be cached may vary according to the size of the bounding box 505. For example, since the capacity required for the image obtained using the bounding box 505 to be cached may vary according to the size of the bounding box 505, the size of the bounding box 505 may be used to determine whether the image obtained using the bounding box 505 is cacheable. According to an embodiment, a method of determining whether the image obtained using the bounding box is cacheable is exemplified in a description of FIG. 6.

FIG. 6 is a flowchart illustrating exemplary operations of an electronic device for determining whether an image, obtained using a bounding box, is cacheable.

According to an embodiment, in an operation 600, the method may include obtaining image using bounding box. For example, the at least one processor 210 may obtain an image including a stroke (e.g., the stroke 410 of FIG. 5) using a bounding box (e.g., the bounding box 505 of FIG. 5). The operation 600 may correspond to the operation 330 of FIG. 3.

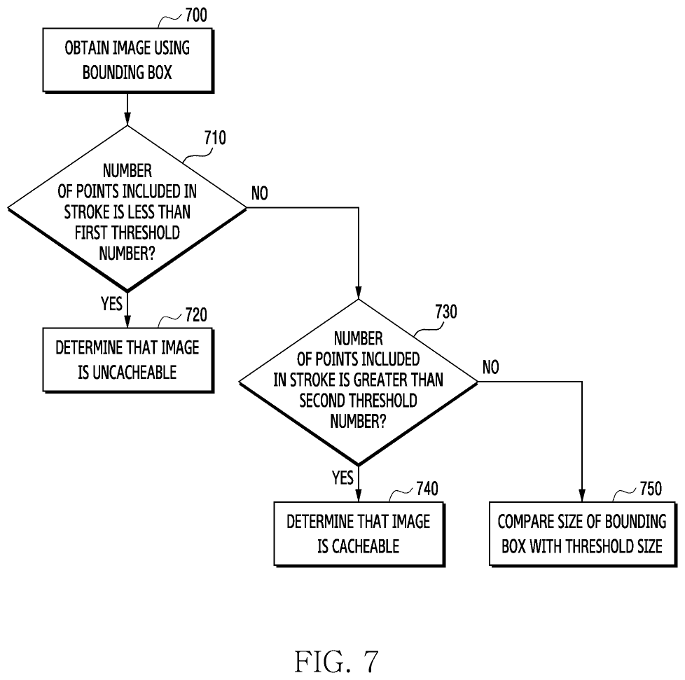

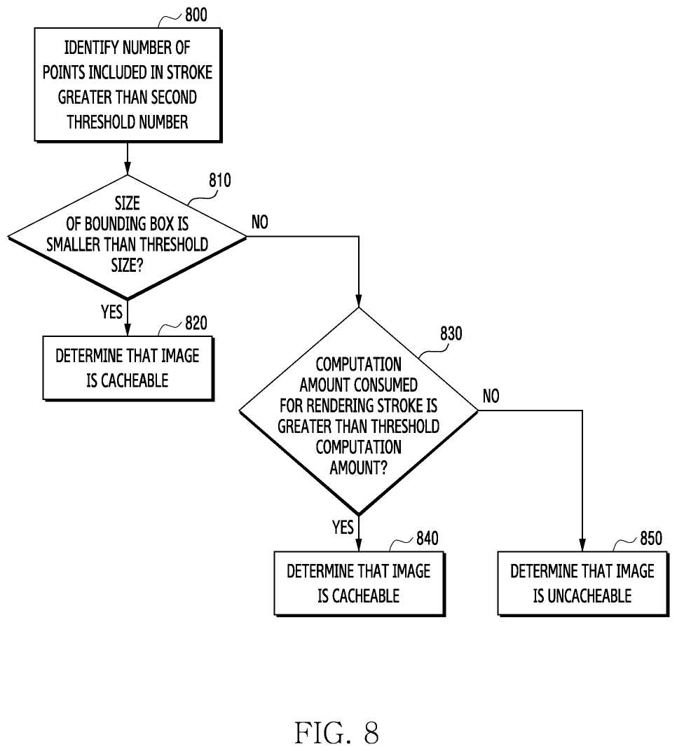

According to an embodiment, in an operation 610, the method may include identifying whether the image is cacheable. For example, the at least one processor 210 may determine whether the image obtained using the bounding box (or obtained by cropping the bounding box) is cacheable based on at least one of the number of points included in the stroke, a size of the bounding box, and/or computation amount (or resource) required for rendering the stroke. For example, the at least one processor 210 may determine whether the image is cacheable by comparing re-rendering the stroke included in the image for editing (e.g., undo, redo, and/or surface change) strokes and retrieving the cached image. According to an embodiment, determining whether the image obtained using the bounding box is cacheable based on at least one of the number of points included in the stroke, the size of the bounding box, and the computation amount required for rendering the stroke is exemplified in a description of FIGS. 7 and 8.

According to another embodiment, the at least one processor 210 may determine whether an image obtained using the bounding box is cacheable based on a state of the electronic device (200). For example, the at least one processor 210 may determine whether the image is cacheable by comparing a capacity of remaining volatile memory (e.g., RAM or a GPU memory buffer) and a capacity of the image obtained using the bounding box. For example, the capacity of the image may indicate an amount of memory required to store the image. For example, the capacity of the image may be a file size of the image. For example, the at least one processor 210 may determine that the image is cacheable based on the capacity of the image obtained using a bounding box smaller than the capacity of the remaining volatile memory (e.g., the RAM or the GPU memory buffer). The at least one processor 210 may determine that the image is uncacheable based on the capacity of the image obtained using a bounding box greater than the capacity of the remaining volatile memory (e.g., the RAM or the GPU memory buffer). For example, the at least one processor 210 may determine whether the image is cacheable further based on a load state of the graphic processing unit (GPU) and the capacity of the volatile memory (e.g., the RAM or the GPU memory buffer) allocated by a currently running program (or an application).

According to an embodiment, in an operation 620, the method may include caching the image and location information of the bounding box. For example, the at least one processor 210 may cache the image obtained using the bounding box and location information of the bounding box based on a determination that the image obtained using the bounding box is cacheable. For example, since the at least one processor 210 may identify only information on a width of the bounding box and a height of the bounding box based on the image obtained using the bounding box, the location information of the bounding box may be cached along with (or in conjunction) with the image. The at least one processor 210 may retrieve the image obtained using the bounding box and the location information of the bounding box again for editing (e.g., undo, redo, and/or surface change) the strokes by caching the image obtained using the bounding box and the location information of the bounding box in the volatile memory (e.g., the random access memory (RAM) or the GPU memory buffer). The at least one processor 210 may bypass (or refrain from, or cease, or not perform re-rendering) re-rendering the stroke included in the image for editing (e.g., undo, redo, and/or surface change) the strokes by caching the image obtained using the bounding box and the location information of the bounding box.

According to an embodiment, the at least one processor 210 may identify a stroke based on a hand gesture in a three dimensional (3D) space. The at least one processor 210 may identify a bounding box surrounding the stroke identified in the 3D space. The at least one processor 210 may obtain an image using the bounding box (by cropping the bounding box) identified in the 3D space. The at least one processor 210 may cache the image and the location information of the bounding box based on the determination that the image is cacheable. The location information of the bounding box identified in the 3D space may further include 6 depth of field (DOF) information. The at least one processor 210 may display the stroke again by loading the cached image onto an original location of the stroke in the 3D space, using the 6DOF information.

According to an embodiment, in an operation 630, the method may include refraining from caching the image and the location information of the bounding box. For example, the at least one processor 210 may refrain from (or cease) caching the image obtained using the bounding box and the location information of the bounding box based on a determination that the image obtained using the bounding box is uncacheable. For example, the at least one processor 210 may determine that the image obtained using the bounding box is uncacheable based on a relatively small computation amount to re-render the stroke included in the image, or that the image has a relatively large capacity. For example, the at least one processor 210 does not cache the image based on a determination that the characteristics of the image and/or the bounding box do not satisfy a criterion. According to an embodiment, determining whether the image obtained using the bounding box is cacheable based on the number of points included in the stroke is exemplified in a description of FIG. 7.

FIG. 7 is a flowchart illustrating exemplary operations of an electronic device for determining whether an image is cacheable based on the number of points included in a stroke.

Referring to FIG. 7, according to an embodiment, in an operation 700, the method may include obtaining an image using a bounding box. For example, the at least one processor 210 may obtain the image including a stroke (e.g., the stroke 410 of FIG. 5) using the bounding box (e.g., the bounding box 505 of FIG. 5) (or by cropping a bounding box). The operation 700 may correspond to the operation 330 of FIG. 3.

According to an embodiment, in an operation 710, the method may identifying whether the number of points included in the stroke is less than a first threshold number. For example, the at least one processor 210 (e.g., a cacheable detecting unit 1615 of FIG. 16) may identify whether the number of points included in the stroke is less than the first threshold number. For example, points included in the stroke may be described as a plurality of points identified in the operation 300 of FIG. 3. The at least one processor 210 may identify the number of points included in the stroke by using a list (e.g., an intermediate point list or a vertex point list) of points included in the stroke. According to the number of points included in the stroke, computation amount required for rendering the stroke may vary. For example, the first threshold number may be set by an application (or an application for editing a stroke) in which a user input is received.

According to an embodiment, in an operation 720, the method may include determining that an image is uncacheable based on a result of the determination in operation 710. For example, the at least one processor 210 (e.g., the cacheable detecting unit 1615 of FIG. 16) may determine that the image is uncacheable based on the number of points included in the stroke being less than the first threshold number. The at least one processor 210 (e.g., the cacheable detecting unit 1615 of FIG. 16) may refrain from caching the image including the stroke and location information of the bounding box based on a determination that the image is uncacheable. For example, a relatively small computation amount may be required to render the stroke including the points less than the first threshold number. According to an embodiment, since the relatively small computation amount is required to render the stroke including the points less than the first threshold number, the at least one processor 210 may display the stroke again by re-rendering the stroke for editing (e.g., undo, redo, and/or surface change) the strokes. For example, the relatively small computation amount may be referred as a computation amount below a reference (or a threshold) amount).

According to an embodiment, in an operation 730, the method may include identifying whether the number of points included in a stroke is greater than a second threshold number. For example, the at least one processor 210 (e.g., the cacheable detecting unit 1615 of FIG. 16) may identify whether the number of points included in a stroke is greater than second threshold number based on the number of points included in the stroke greater than the first threshold number. The second threshold number may be higher than the first threshold number. For example, the second threshold number may be set by an application (or an application for editing the stroke) in which the user input is received.

According to an embodiment, in an operation 740, the method may include determining that an image is cacheable based on the number of points included in a stroke being greater than the second threshold number. For example, the at least one processor 210 (e.g., the cacheable detecting unit 1615 of FIG. 16) may determine that the image is cacheable based on the number of points included in the stroke being greater than the second threshold number. The at least one processor 210 may cache the image including the stroke and location information of a bounding box based on a determination that the image is cacheable. For example, a relatively large computation amount may be required to render the stroke including the number of points greater than the second threshold number. According to an embodiment, since the relatively large computation amount is required to render the stroke including the number of points greater than the second threshold number, the at least one processor 210 may bypass (or refrain from, or not perform rendering) re-rendering the stroke for editing (e.g., undo, redo, and/or surface change) the strokes and display the stroke again using the cached image and the location information of the bounding box. For example, the relatively large computation amount may be refer as a computation amount above a reference (or a threshold) amount).

According to an embodiment, in an operation 750, the method may include comparing a size of a bounding box with a threshold size based on the number of points included in the stroke being less than the second threshold number. For example, the at least one processor 210 (e.g., the cacheable detecting unit 1615 of FIG. 16) may compare the size of the bounding box with the threshold size based on the number of points included in the stroke being less than the second threshold number. The size of the bounding box may be described as the size of the bounding box identified in the operation 320 of FIG. 3. For example, according to the size of the bounding box, a capacity of the image obtained using the bounding box (or by cropping the bounding box) may vary. For example, the threshold size may be set by an application (or an application for editing the stroke) in which the user input is received. Determining whether the image is cacheable, based on the size of the bounding box, is exemplified in a description of FIG. 8.

FIG. 8 is a flowchart illustrating exemplary operations of an electronic device for determining whether an image is cacheable based on a size of a bounding box and/or computation amount required for rendering a stroke.

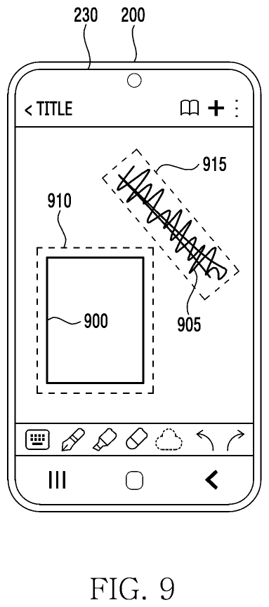

Referring to FIG. 8, according to an embodiment, in an operation 800, the method may include identifying a number of points included in a stroke greater than a second threshold number. For example, the at least one processor 210 may identify the number of points included in a stroke greater than second threshold number. For example, the operation 800 may correspond to the operation 730 of FIG. 7. According to an embodiment, determining whether an image is cacheable based on the number of points included in the stroke is exemplified in the description of FIG. 9.

According to an embodiment, in an operation 810, the method may include comparing a size of a bounding box with a threshold size. For example, the at least one processor 210 (e.g., a bounding box checking unit 1620 of FIG. 16) may compare the size of the bounding box with the threshold size. For example, the operation 810 may correspond to the operation 750 of FIG. 7. According to an embodiment, determining whether an image is cacheable based on the size of the bounding box is exemplified in a description of FIG. 9.

According to an embodiment, in an operation 820, the method may include determining that an image is cacheable based on the size of the bounding box being smaller than the threshold size. For example, the at least one processor 210 (e.g., the bounding box checking unit 1620 of FIG. 16) may determine that the image is cacheable based on the size of the bounding box being smaller than the threshold size. The at least one processor 210 (e.g., the bounding box checking unit 1620 of FIG. 16) may cache the image including the stroke and location information of the bounding box based on a determination that the image is cacheable. An image obtained using the bounding box having a size less than the threshold size may have a relatively small capacity. For example, since the image obtained using the bounding box having the size less than the threshold size has the relatively small capacity, the at least one processor 210 may bypass (or refrain from, or not perform rendering) re-rendering the stroke for editing (e.g., undo, redo, and/or surface change) the strokes and display the stroke again using the cached image and the location information of the bounding box.

According to an embodiment, in an operation 830, the method may include comparing computation amount required for rendering the stroke with a threshold computation amount based on the bounding box having the size larger than the threshold size. For example, the at least one processor 210 (e.g., a render cost checking unit 1630 of FIG. 16) may compare computation amount required for rendering a stroke with threshold computation amount based on the bounding box having the size larger than the threshold size. For example, an image obtained using the bounding box having the size greater than the threshold size may have a relatively large capacity. As the image obtained using the bounding box having the size greater than the threshold size has the relatively large capacity, the computation amount required for rendering the stroke may be compared with the threshold computation to identify whether the image is cacheable. The computation amount required for rendering the stroke may be described as the amount of computation identified in the operation 310 of FIG. 3. For example, the computation amount required for rendering the stroke may be referred to as a render cost. For example, the amount of computation required to render a stroke may be determined by the stroke type, a length of a stroke 410, and/or resolution of the stroke 410. The stroke type may include a pen type, a thickness of the stroke, and/or a color of the stroke. The amount of computation required for rendering the stroke may be identified by rendering the stroke to display the stroke. For example, the threshold computation amount may be set by an application (or an application for editing a stroke) in which a user input is received.

According to an embodiment, in an operation 840, the method may include determining that the image is cacheable based on the computation amount required for rendering the stroke being greater than threshold computation amount. For example, the at least one processor 210 may determine that the image is cacheable based on computation amount required for rendering the stroke greater than the threshold computation amount. The at least one processor 210 may cache the image including the stroke and location information of a bounding box based on the determination that the image is cacheable. The computation amount required for rendering the stroke greater than the threshold computation amount may be relatively large. For example, since a relatively large computation amount is required to render the stroke, the at least one processor 210 may bypass (or refrain from, or not perform rendering) re-rendering the stroke for editing (e.g., undo, redo, and/or surface change) the strokes, and display the stroke again using the cached image and the location information of the bounding box.

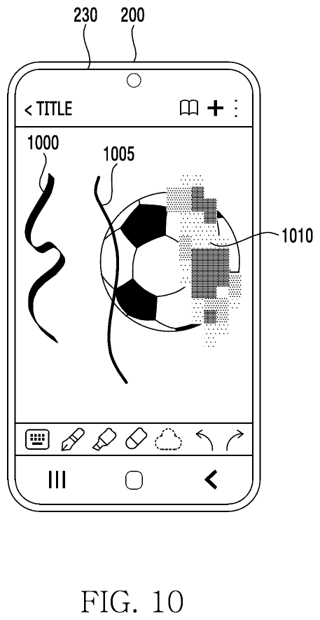

According to an embodiment, in an operation 850, the method may include determining that the image is uncacheable based on the computation amount required for rendering the stroke being smaller than the threshold computation amount. For example, the at least one processor 210 may determine that an image is uncacheable based on computation amount required for rendering a stroke smaller than threshold computation amount. The at least one processor 210 may refrain from caching the image including the stroke and location information of a bounding box based on a determination that the image is uncacheable. The computation amount required for rendering the stroke smaller than the threshold computation amount may be relatively small. For example, since the relatively small computation amount is required for rendering the stroke, the at least one processor 210 may display the stroke again by re-rendering the stroke for editing (e.g., undo, redo, and/or surface change) the strokes. For example, the computation amount required for rendering the stroke may vary according to a pen type of the stroke. The computation amount required for rendering the stroke according to the pen type of the stroke is illustrated in a description of FIG. 10.

FIG. 9 illustrates an example of determining whether an image is cacheable based on the number of points included in a stroke and/or a size of a bounding box.

Referring to FIG. 9, according to an embodiment, the at least one processor 210 may identify a stroke 900 and/or a stroke 905 based on a user input received via a display 230. The at least one processor 210 may display the stroke 900 and/or the stroke 905 via the display 230, based on rendering the stroke 900 and/or the stroke 905. The stroke 900 and/or stroke 905 may include a plurality of points.

According to an embodiment, as the stroke 900 is substantially configured with straight lines, the number (e.g., five, but the disclosure is not limited thereto) of points included in the stroke 900 may be relatively small. For example, as the number (e.g., five) of points included in the stroke 900 is relatively small, computation amount required for rendering the stroke 900 may be relatively small. For example, since the computation amount required for rendering the stroke is relatively small, the at least one processor 210 may display the stroke 900 again by re-rendering the stroke 900, instead of caching an image obtained using a bounding box 910 for editing (e.g., undo, redo, and/or surface change) strokes. For example, the number (e.g., five) of points included in the stroke 900 may be less than a threshold number (e.g., the first threshold number of FIG. 7). The at least one processor 210 may determine that the image obtained using the bounding box 910 is uncacheable based on the number (e.g., five) of points included in the stroke 900 less than the threshold number.

According to an embodiment, since the stroke 905 is configured with curves and has a relatively long length, the number of points included in the stroke 905 may be relatively large. For example, as the number of points included in the stroke 905 is relatively large, computation amount required for rendering the stroke 905 may be relatively large. For example, since the computation amount required for rendering the stroke is relatively large, the at least one processor 210 may display the stroke 905 again by retrieving a cached image, instead of re-rendering the stroke for editing (e.g., undo, redo, and/or surface change) strokes. The number of points included in the stroke 900 may be greater than a threshold number (e.g., the second threshold number of FIG. 7). The at least one processor 210 may determine that the image obtained using the bounding box 915 is cacheable based on the number of points included in the stroke 905 greater than the another threshold number.

According to an embodiment, the bounding box 910 surrounding the stroke 900 may have a size larger than the bounding box 915 surrounding the stroke 905. For example, the bounding box 910 surrounding the stroke 900 may be larger than a threshold size (e.g., the threshold size of FIG. 8), and the bounding box 915 surrounding the stroke 905 may be smaller than the threshold size (e.g., the threshold size of FIG. 8).

According to an embodiment, since the bounding box 910 surrounding the stroke 900 has the relatively large size, the image obtained using the bounding box 910 surrounding the stroke 900 may have a relatively large capacity. As the image obtained using the bounding box 910 has the relatively large capacity, remaining capacity of relatively large volatile memory (e.g., RAM or a GPU memory buffer) may be required to cache the image obtained using the bounding box 910. For example, since the remaining capacity of the relatively large volatile memory (e.g., the RAM or the GPU memory buffer) is required to cache the image obtained using the bounding box 910, the at least one processor 210 may display the stroke 900 again by re-rendering the stroke 900 instead of caching the image obtained using the bounding box 910 for editing (e.g., undo, redo, and/or surface change) strokes. The at least one processor 210 may determine that the image obtained using the bounding box 910 is uncacheable based on the size of the bounding box 910 larger than the threshold size.

According to an embodiment, since the bounding box 915 surrounding the stroke 905 has the relatively small size, the image obtained using the bounding box 915 surrounding the stroke 905 may have a relatively small capacity. As the image obtained using the bounding box 915 has the relatively small capacity, remaining capacity of relatively small volatile memory (e.g., the RAM or the GPU memory buffer) may be required to cache the image obtained using the bounding box 915. For example, since the remaining capacity of the relatively small volatile memory (e.g., the RAM or the GPU memory buffer) is required to cache the image obtained using the bounding box 915, the at least one processor 210 may display the stroke 905 again by retrieving the cached image instead of re-rendering the stroke for editing (e.g., undo, redo, and/or surface change) strokes. The at least one processor 210 may determine that the image obtained using the bounding box 915 is cacheable based on the size of the bounding box 915 smaller than the threshold size.

According to an embodiment, as the stroke 900 includes a relatively small number of points and the bounding box 910 has the relatively large size, the at least one processor 210 may determine that the image obtained using the bounding box 910 is uncacheable. The at least one processor 210 may determine that the image obtained using the bounding box 915 is uncacheable as the stroke 905 includes a relatively large number of points and the bounding box 915 has a relatively small size.

FIG. 10 illustrates an example of computation amount according to a pen type of a stroke.

Referring to FIG. 10, according to an embodiment, the at least one processor 210 may identify a stroke 1000, a stroke 1005, and a stroke 1010 based on a user input received via a display 230. The at least one processor 210 may display the stroke 1000, the stroke 1005, and the stroke 1010 on the display 230 based on rendering the stroke 1000, the stroke 1005, and the stroke 1010. For example, the stroke 1000, the stroke 1005, and the stroke 1010 may have a different pen type from each other. The computation amount (e.g., a render cost) required for rendering the stroke may vary according to the pen type that the stroke has.

According to an embodiment, the pen type of the stroke 1000 may be described as a pen type (e.g., a calligraphy pen type) in which a width (or a thickness) of a line is determined according to a direction of the line included in the stroke 1000. For example, since the width (or the thickness) of the line is determined according to the direction of the line included in the stroke 1000, it may not be required to apply an angle tip to a curve configuring a corner of the stroke 1000 to render the stroke 1000. According to an embodiment, applying the angle tip may increase the number of vertex points included in the stroke in order for the curve configuring the corner of the stroke to be seen naturally (or smoothly). In stroke 1000, it is not required to apply the angle tip to the curve configuring the corner of the stroke 1000 to render the stroke 1000, and as such, the computation amount (e.g., the render cost) required for rendering the stroke 1000 may be relatively small.

According to an embodiment, the pen type of the stroke 1005 may be described as a normal pen type. For example, in order to render the stroke 1005, it may be required to apply the angle tip to a curve configuring a corner of the stroke 1005. The at least one processor 210 may naturally (or gently) represent the curve configuring the corner of the stroke 1005 by applying relatively many angle tips to the curve according to an interior angle and an exterior angle of the curve configuring the corner of the stroke 1005 to render the stroke 1005. In stroke 1005, it is required to apply the angle tip to the curve configuring the corner of the stroke 1005 to render the stroke 1005, and as such, the computation amount (e.g., the render cost) required for rendering the stroke 1005 may be relatively large.

According to an embodiment, the pen type of the stroke 1010 may be described as a mosaic pen type. For example, in order to render the stroke 1010, it may be further required to apply an angle tip to a curve configuring a corner of the stroke 1010 and to detect a background area of the stroke 1010. The at least one processor 210 may perform block processing of the stroke 1010 according to pixels included in the stroke 1010 based on detecting the background area of the stroke 1010. For example, based on a color corresponding to the background area of the stroke 1010, the at least one processor 210 may display a block having the color in the stroke 1010. In stroke 1010, it is further required to apply the angle tip to the curve configuring the corner of the stroke 1010 to render the stroke 1010, and to perform the block processing of the stroke 1010, and as such, the computation amount (e.g., render cost) required for rendering the stroke 1010 having the mosaic pen type may be greater than the computation amount (e.g., render cost) required for rendering the stroke 1005 having the general pen type.

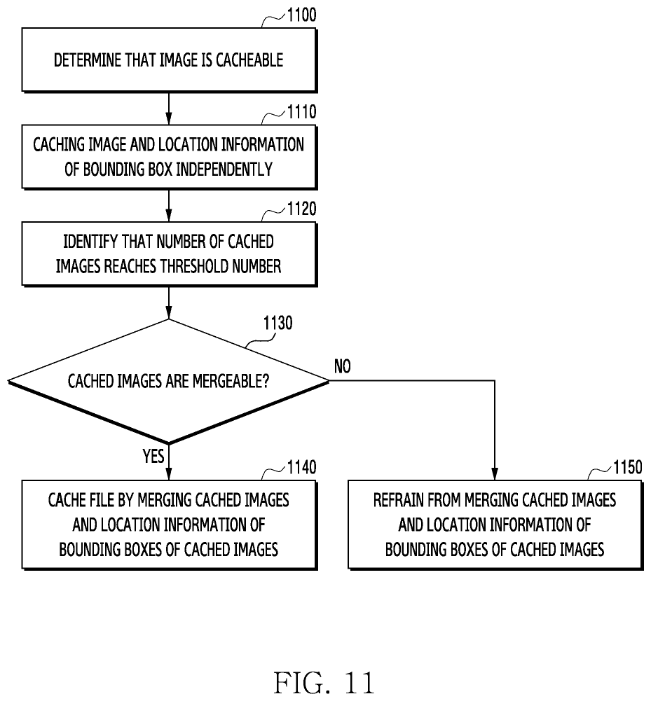

FIG. 11 is a flowchart illustrating exemplary operations of an electronic device for determining whether cached images are mergeable.

Referring to FIG. 11, according to an embodiment, in an operation 1100, the method may include determining that the image is cacheable. For example, the at least one processor 210 may determine that an image obtained using a bounding box is cacheable based on at least one of the number of points included in a stroke, a size of the bounding box, and/or computation amount required for rendering the stroke. The operation 1100 may correspond to the operation 740 of FIG. 7, the operation 820 of FIG. 8, and the operation 840 of FIG. 8.

According to an embodiment, in an operation 1110, the method may include caching the image independently based on a determination that the image is cacheable. For example, the at least one processor 210 (e.g., a stroke container cluster unit 1635 of FIG. 16) may independently cache an image obtained using the bounding box and location information of the bounding box based on a determination that the image obtained using the bounding box is cacheable. The at least one processor 210 may cache the image and the location information of the bounding box in a unit of a caching block. For example, the caching block may be referred to as a stroke container. The caching block (or the stroke container) may be categorized (or classified) according to a level. For example, in the caching block (or the stroke container) of level 1, an image and location information of the bounding box may be cached. For example, caching the image and the location information of the bounding box independently may be caching the image and the location information of the bounding box in the caching block (or the stroke container) of level 1.

According to an embodiment, in an operation 1120, the method may include identify that the number of cached images reaches a threshold number. For example, the at least one processor 210 (e.g., the stroke container cluster unit 1635 of FIG. 16) may identify that the number of cached images reaches a threshold number. The number of cached images may correspond to the number of caching blocks (or stroke containers) of level 1 in which the image and the location information of bounding box are cached. For example, the number of cached images may further include the number of cacheable images and the number of uncacheable images. For example, the threshold number may be described as the number (e.g., five) of images that may be cached in the caching block (or the stroke container) of level 2.

According to an embodiment, in an operation 1130, the method may include determining whether the cached images are mergeable based on the number of cached images reaching the threshold number. For example, the at least one processor 210 (e.g., the stroke container cluster unit 1635 of FIG. 16) may determine whether the cached images are mergeable based on the number of cached images reaching the threshold number. The at least one processor 210 may determine whether the cached images with respect to a state of an electronic device 200 are mergeable. For example, the state of the electronic device 200 may be related to a load state of a GPU, limitation of volatile memory (e.g., RAM or a GPU memory buffer), and a currently running program (or application).

According to an embodiment, in an operation 1140, the method may include caching a file by merging the cached images and location information of bounding boxes of the cached images. For example, the at least one processor 210 (e.g., the stroke container cluster unit 1635 of FIG. 16) may, based on determining that the cached images are mergeable, cache a file in which the cached images and location information of bounding boxes of the cached images are merged. For example, caching to the file by merging the cached images and the location information of the bounding boxes of the cached images may be described as caching the cached images and the location information of the bounding boxes of the cached images in the caching block (or the stroke container) of level 2. For example, caching the images to each of a plurality of caching blocks (or stroke containers) of level 1 may require relatively more volatile memory (e.g., the RAM or the GPU memory buffer) than caching the images in the caching block (or the stroke container) of level 2. The at least one processor 210 may determine that the cached images are mergeable as a capacity of the volatile memory (e.g., the RAM or the GPU memory buffer) for caching the images in each of the plurality of caching blocks (or stroke containers) of level 1 is insufficient. By merging (or by clustering) the caching blocks (or the stroke containers) of level 1, the at least one processor 210 may cache the cached images and the location information of the bounding boxes of the cached images in the caching block (or the stroke container) of level 2. For example, the caching block (or the stroke container) of level 2 may include cacheable images and/or uncacheable images.

According to an embodiment, in an operation 1150, the method may include refraining from merging the cached images and the location information of the bounding boxes of the cached image. For example, the at least one processor 210 (e.g., the stroke container cluster unit 1635 of FIG. 16) may, based on a determination that the cached images are unmergeable, refrain from merging the cached images and the location information of the bounding boxes of the cached images. By refraining from merging (or clustering) the caching blocks (or the stroke containers) of level 1, the at least one processor 210 may maintain caching each of the images in the caching blocks (or the stroke containers) of level 1. The at least one processor 210 may determine that the cached images are unmergeable as the capacity of the volatile memory (e.g., the RAM or the GPU memory buffer) for caching images in each of the plurality of caching blocks (or the stroke containers) of level 1 is sufficient.

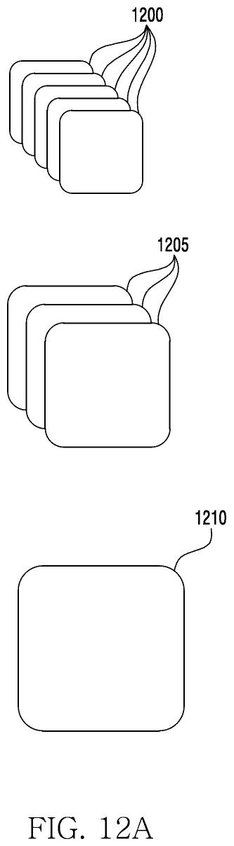

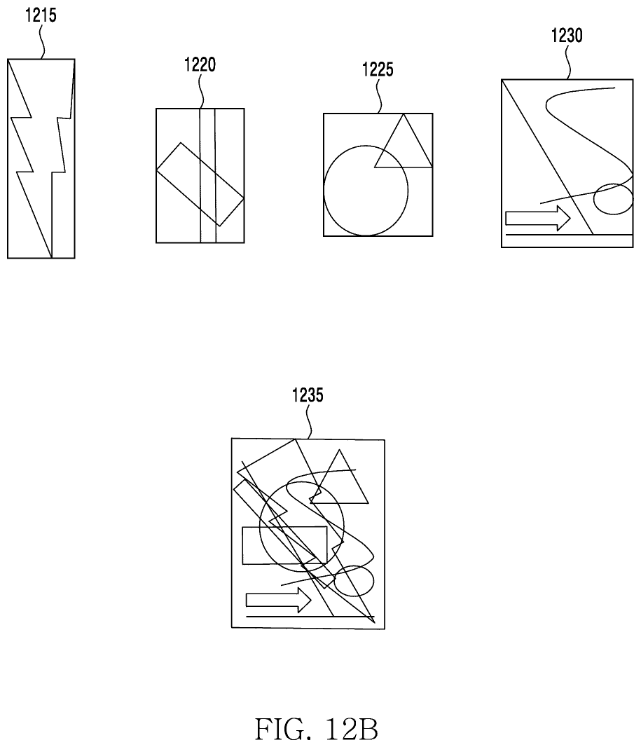

According to an embodiment, the at least one processor 210 (e.g., the stroke container cluster unit 1635 of FIG. 16) may obtain a caching block (or a stroke container) of level 3 by merging the caching blocks (or the stroke containers) of level 2. An example of merging the caching blocks (or the stroke containers) is illustrated in a description of FIG. 12A.

FIG. 12A illustrates an example of merging images and location information of bounding boxes according to a level.

Referring to FIG. 12A, according to an embodiment, the at least one processor 210 may cache an image obtained using the bounding box and the location information of the bounding box in a caching block (or a stroke container) 1200 of level 1. In the caching block (or the stroke container) 1200 of level 1, only an image of a stroke and the location information of the bounding box may be cached. Caching a plurality of strokes to each caching block (or the stroke container) 1200 of level 1 may cause a lack of capacity of volatile memory (e.g., RAM or a GPU memory buffer). To solve the lack of capacity of the volatile memory (e.g., the RAM or the GPU memory buffer), the at least one processor 210 may obtain a caching block (or a stroke container) 1205 of level 2 by merging the caching block (or the stroke container) 1200 of level 1.

According to an embodiment, the at least one processor 210 (e.g., a stroke container cluster unit 1635 of FIG. 16) may determine whether cached images (or the caching blocks 1200 of level 1) are mergeable based on the number of cached images (or the number of the caching block 1200 of level 1) reaching a threshold number (e.g., five). The threshold number may vary according to a state of an electronic device 200. The at least one processor 210 may determine whether the cached images (or the caching blocks 1200 of level 1) are mergeable with respect to the state of the electronic device 200 (e.g., limitation of the volatile memory (e.g., the RAM or the GPU memory buffer) and/or a currently running a program (or an application)).

According to an embodiment, the at least one processor 210 (e.g., the stroke container cluster unit 1635 of FIG. 16) may, based on a determination that the cached images are mergeable, cache into a file by merging the cached images and location information of bounding boxes of the cached images. For example, caching into the file by merging the cached images and the location information of the bounding boxes of the cached images may include caching the cached images and the location information of the bounding boxes of the cached images into the caching block (or the stroke container) 1205 of level 2. The at least one processor 210 may obtain the caching block (or the stroke container) 1205 of level 2 by merging (or clustering) the caching blocks (or the stroke containers) 1200 of level 1. For example, the caching block (or stroke the container) 1205 of level 2 may cache images of the threshold number (e.g., five).

According to an embodiment, the at least one processor 210 (e.g., the stroke container cluster unit 1635 of FIG. 16) may identify that the number of files in which the cached images and the location information of bounding boxes of the cached images are merged reaches another threshold number. The number of merged files (or files cached as a file) may correspond to the number of caching blocks (or stroke containers) 1205 of level 2. For example, the another threshold number may be described as the number (e.g., 10) of caching blocks (or stroke containers) 1205 of level 2 to be merged to obtain a caching block (or a stroke container) 1210 of level 3. For example, the another threshold number may be changed according to the state of the electronic device 200. For example, the caching block (or the stroke container) 1210 of level 3 may be configured with the caching blocks (or the stroke containers) 1205 of level 2. The at least one processor 210 may cache the number (e.g., 50) of images multiplied by the number of caching blocks (or the stroke containers) 1205 of level 2 by the number of images included in caching block (or the stroke container) 1205 of level 2 in the caching block (or the stroke container) 1210 of level 3. The at least one processor 210 may determine whether merged files (or files cached in a file) are mergeable based on the number of the merged files (or files cached in a file) reaching another threshold number. The at least one processor 210 may determine whether the merged files (or the caching blocks 1205 of level 2) are mergeable with respect to a state of the electronic device 200 (e.g., limitation of volatile memory (e.g., RAM or a GPU memory buffer) and/or a currently running program (or application)).

According to an embodiment, the at least one processor 210 may cache a file in which the files are merged by merging (or clustering) the files again based on determining that the merged files are mergeable. For example, caching a file in which the files are merged may be described as caching the files in the caching block (or the stroke container) 1210 of level 3. The at least one processor 210 may obtain the caching block (or the stroke container) 1210 of level 3 by merging (or clustering) the caching blocks (or the stroke containers) 1205 of level 2. As an example without limitation, the at least one processor 210 may determine whether the caching blocks (or the stroke containers) 1210 of level 3 are mergeable based on the number of caching blocks (or stroke containers) 1210 of level 3 reaching a reference number. The at least one processor 210 may obtain a caching block (or stroke container) of level 4 by merging the caching blocks (or stroke containers) 1210 level 3 based on determining that the caching blocks (or the stroke containers) 1210 of level 3 are mergeable with respect to the state of the electronic device 200. However, it is not limited thereto.

According to another embodiment, the at least one processor 210 may merge the caching blocks (or the stroke containers) 1200 of level 1 and the caching blocks (or the stroke containers) 1205 of level 2. The at least one processor 210 may obtain a caching block (or stroke container) of different levels by merging caching blocks (or stroke containers) of different levels.

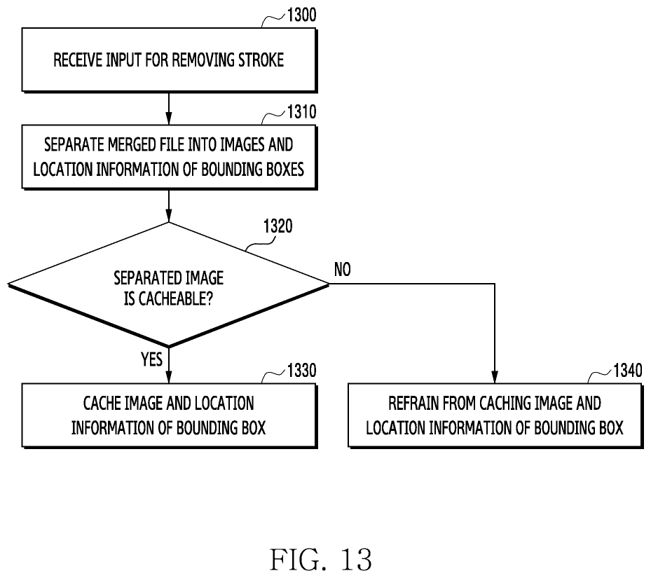

According to another embodiment, the at least one processor 210 may monitor a state of the electronic device 200. For example, the at least one processor 210 may identify the changed state of the electronic device 200 by monitoring the state of the electronic device 200. The at least one processor 210 may re-merge or separate the caching blocks (or the stroke containers) based on the changed state of the electronic device 200. Separating the caching block (or the stroke container) is illustrated in a description of FIG. 13.

FIG. 12B illustrates an example of cached images in a caching block according to an embodiment.

Referring to FIG. 12B, according to an embodiment, the at least one processor 210 may cache an image obtained using the bounding box and location information of the bounding box in a caching block (or a stroke container) 1215 of level 1. In the caching block (or the stroke container) 1215 of level 1, an image of a stroke and the location information of a bounding box may be cached. The at least one processor 210 may determine whether the caching blocks (or the stroke containers) 1215 of level 1 are mergeable based on the caching blocks 1215 of level 1 reaching a threshold number (e.g., two).

According to an embodiment, the at least one processor 210 may generate (or obtain) caching blocks (or stroke containers) 1220 and 1225 of level 2, by merging the caching blocks 1215 of level 1, based on a determination that the caching blocks 1215 of level 1 are mergeable. In the caching blocks (or the stroke containers) 1220 and 1225 of level 2, images obtained using the bounding box and the location information of the bounding box may be cached into a file. The at least one processor 210 may, based on the caching blocks 1220 and 1225 of level 2 reaching another threshold number, determine whether the caching blocks 1220 and 1225 of level 2 are mergeable. The at least one processor 210 may, based on a determination that the caching blocks 1220 and 1225 of level 2 are unmergeable, maintain the caching blocks 1220 and 1225 of level 2. The at least one processor 210 may monitor whether the caching blocks 1220 and 1225 of level 2 are mergeable with respect to a state of the electronic device while the caching blocks 1220 and 1225 of level 2 are maintained.

According to an embodiment, the at least one processor 210 may obtain (or generate) a caching block (or a stroke container) 1230 of level 3, by merging the caching blocks 1220 and 1225 of level 2, based on a determination that the caching blocks 1220 and 1225 of level 2 are mergeable. The at least one processor 210 may separate the caching blocks 1220 and 1225 of level 2 into images obtained using the bounding box and location information of the bounding box, and cache the separated images and location information of the bounding box back to a file. For example, the caching block 1230 of level 3 may include a stroke of a number (e.g., four) multiplied by the number (e.g., two) of the caching blocks 1220, and 1225 of level 2 and the number (e.g., two) of strokes included in each of the caching blocks 1220 and 1225 of level 2.

According to an embodiment, an image 1235 may represent an image including strokes according to a user input (e.g., a handwriting input). The strokes in the image 1235 may be cached by being separated (or categorized) in the caching blocks 1215, 1220, 1225, and 1230 of each level. The at least one processor 210 may bypass (or refrain from, or cease, or not perform rendering) re-rendering the stroke included in the image 1235 for editing (e.g., undo, redo, and/or surface change) of strokes by separating and caching the strokes in the image 1235 into the caching blocks 1215, 1220, 1225, and 1230 of each level.

FIG. 13 is a flowchart illustrating exemplary operations of an electronic device for separating a merged file into images and location information of bounding boxes.

Referring to FIG. 13, in an operation 1300, the method may include receiving an input for removing a stroke. For example, the at least one processor 210 may receive an input for removing a stroke. The input for removing the stroke may be described as an input 125 (or an undo input) for removing the stroke 115-3 of FIG. 1A.

According to an embodiment, in an operation 1310, the method may include separating the merged file into images and the location information of the bounding boxes based on receiving the input for removing stroke. For example, the at least one processor 210 may separate the merged file into images and the location information of the bounding boxes based on an input for removing stroke received while an image including the stroke and other images are cached in a file. For example, an image and other images including the stroke to be removed may be cached in a caching block (or a stroke container) at a second level (or a third level). The at least one processor 210 may separate the caching block (or the stroke container) of the second level (or the third level) into a caching block (or a stroke container) of a first level in order to cease displaying the stroke to be removed and to re-display remaining strokes except for the stroke to be removed. In the separated caching block (or the stroke container) of the first level, the image including the stroke to be removed and the location information of the bounding box may be cached to be reused (e.g., to provide a response to a redo input).

According to an embodiment, in an operation 1320, the method may include determining whether one or more of the separated images is cacheable. For example, the at least one processor 210 may determine whether each of the other images except for the image including the stroke to be removed is cacheable. Determining whether each of the other images is cacheable may correspond to the operation 610 of FIG. 6. The at least one processor 210 may determine whether each of the other images is cacheable with respect to a state of an electronic device 200. The at least one processor 210 may determine whether each of the other images is cacheable based on at least one of the number of points included in the stroke, a size of the bounding box, and/or computation amount required for rendering the stroke.

According to an embodiment, in an operation 1330, the method may include caching the one or more of the separated images determined to be cacheable. For example, the at least one processor 210 may cache the images determined to be cacheable and the location information of each of the bounding boxes, based on the images determined to be cacheable among the other images. The at least one processor 210 may cache each of the images determined to be cacheable in the caching block (or the stroke container) of level 1.

According to an embodiment, in an operation 1340, the method may include refraining from caching images determined to be uncacheable. For example, the at least one processor 210 may refrain from caching images determined to be uncacheable, based on images determined to be uncacheable among the other images.

According to another embodiment, the at least one processor 210 may separate an image including the stroke and a caching block (or a stroke container) in which another image is merged in advance before removing the stroke. For example, the at least one processor 210 may cease displaying the stroke relatively quickly according to receiving an input (e.g., an undo input) for removing the stroke, and re-display remaining strokes except for the stroke, by separating the image including the stroke and the caching block (or the stroke container) in which the another image is merged in advance before removing the stroke. For example, the at least one processor 210 may separate an image including the stroke and the caching block (or the stroke container) in which another image is merged, based on the number of strokes after the stroke reaches less than or equal to a threshold number according to an input (e.g., an undo input) to remove a stroke after a stroke.

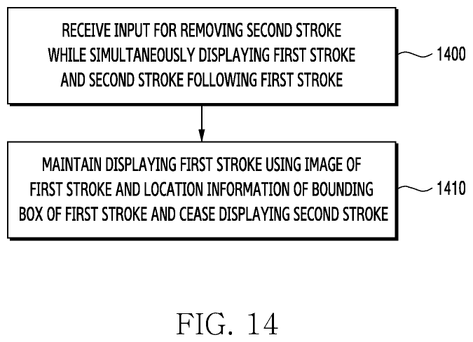

According to an embodiment, the at least one processor 210 may cease (or refrain from) displaying the stroke based on the input (e.g., the undo input) for removing the stroke, and may re-display the remaining strokes except for the stroke. Ceasing (or refraining from) displaying the stroke to be removed and re-displaying the remaining strokes except for the stroke is illustrated in a description of FIG. 14.

FIG. 14 is a flowchart illustrating exemplary operations of an electronic device for removing a stroke.

Referring to FIG. 14, in an operation 1400, the method may include receiving input for removing second stroke while displaying first stroke and second stroke following the first stroke. For example, the at least one processor 210 may identify a first stroke based on a user input via a display 230. The at least one processor 210 may display the first stroke on the display 230 based on rendering the first stroke. The at least one processor 210 may identify a second stroke following (or immediately following) the first stroke based on the user input via the display 230. The at least one processor 210 may simultaneously display the first stroke and the second stroke on the display 230 based on rendering the second stroke.

According to an embodiment, the at least one processor 210 may receive an input (e.g., an undo input) for removing the second stroke while simultaneously displaying the first stroke and the second stroke. The input for removing the second stroke may be described as the input 125 (or undo input) for removing the stroke 115-3 of FIG. 1A. For example, an image including the first stroke (or an image obtained using a bounding box surrounding the first stroke) may be described as an image determined to be cacheable. Based on a determination that the image including the first stroke is cacheable, the image including the first stroke and location information of the bounding box surrounding the first stroke may be cached.

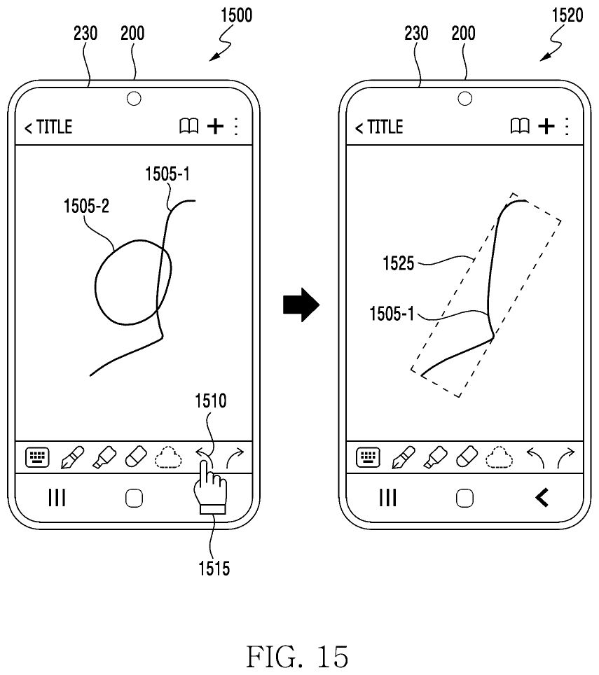

According to an embodiment, in operation 1410 the method may include ceasing from (or refraining from) displaying the second stroke by removing the second stroke based on an input (e.g., undo input) for removing the second stroke. For example, the at least one processor 210 may maintain displaying the first stroke by re-displaying the first stroke using the cached image of the first stroke (or the image obtained using the bounding box surrounding the first stroke) and the location information of the bounding box. The at least one processor 210 may bypass (or refrain from, or not perform rendering) to re-render the first stroke and display the first stroke again based on the cached image and location information of the bounding box. The at least one processor 210 may reduce power consumed for rendering the first stroke by bypassing re-rendering the first stroke. Bypassing re-rendering the first stroke, the at least one processor 210 may prevent performance degradation of the electronic device 200 caused by re-rendering the first stroke. Removing the second stroke according to the input for removing the second stroke is illustrated in a description of FIG. 15.

FIG. 15 illustrates an example of removing a stroke according to an embodiment.

Referring to FIG. 15, a state 1500 may be described as a state in which a first stroke 1505-1 and a second stroke 1505-2 are displayed. According to an embodiment, the at least one processor 210 may receive an input 1515 for an executable object 1510. The input to the executable object 1510 may be described as an undo input. The undo input may be described as an input for removing the last displayed (or identified) stroke.

According to an embodiment, an electronic device 200 may switch from the state 1500 to a state 1520 based on receiving the input 1515 for the executable object 1510 while the first stroke 1505-1 and the second stroke 1505-2 are displayed. In the state 1520, the at least one processor 210 may cease displaying the second stroke 1505-2 by removing the second stroke 1505-2 based on receiving the input 1515 for the executable object 1510 while the first stroke 1505-1 and the second stroke 1505-2 are displayed.

According to an embodiment, an image including the first stroke 1505-1 (or an image obtained using a bounding box 1525, or an image cropped by the bounding box 1525) may be described as a cacheable image. According to an embodiment, based on a determination that the image including the first stroke 1505-1 is cacheable, the image including the first stroke 1505-1 and location information of the bounding box 1525 (e.g., a coordinate of a center point of the bounding box 1525 and orientation of the bounding box 1525) may be cached. According to an embodiment, based on receiving the input 1515 for the executable object 1510 while the first stroke 1505-1 and the second stroke 1505-2 are displayed, the at least one processor 210 may display the first stroke 1505-1 again using the image including the cached first stroke 1505-1, and the location information of the bounding box 1525. The at least one processor 210 may display the first stroke 1505-1 again by rotating the image including the first stroke 1505-1 on the coordinate of the center point of the bounding box 1525, according to the orientation of the bounding box 1525. The at least one processor 210 may maintain displaying the first stroke 1505-1 by displaying the first stroke 1505-1 again.

According to an embodiment, the at least one processor 210 may bypass (or refrain from, or not display) re-rendering the first stroke 1505-1 by displaying the first stroke 1505-1 using the image including the cached first stroke 1505-1 and the location information of the bounding box 1525. The at least one processor 210 may reduce power consumed for rendering the first stroke 1505-1 by bypassing re-rendering the first stroke 1505-1. Bypassing re-rendering the first stroke 1505-1, the at least one processor 210 may prevent performance degradation of the electronic device 200 caused by re-rendering the first stroke 1505-1. The at least one processor 210 may cease displaying the second stroke 1505-2 in response to the input 1515 and maintain displaying the first stroke 1505-1.

According to an embodiment, only the first stroke 1505-1 and the second stroke 1505-2 are illustrated in FIG. 15, but the at least one processor 210 may receive the input 1515 for removing the second stroke 1505-2 while further displaying other strokes. The at least one processor 210 may use the image of the cached first stroke 1505-1 and the other strokes to maintain displaying the first stroke 1505-1 and the other strokes based on the input 1515 for removing the second stroke 1505-2.

FIG. 16 illustrates exemplary configurations of an electronic device according to an embodiment.

Referring to FIG. 16, the electronic device 200 may include a bounding box generating unit 1600, a cacheable detecting unit 1615, and/or a stroke container cluster unit 1635. The bounding box generating unit 1600 may include a box area calculating unit 1605 and/or a transform extracting unit 1610. The cacheable detecting unit 1615 may include a bounding box checking unit 1620, a stroke size checking unit 1625, and/or a render cost checking unit 1630. The stroke container cluster unit 1635 may include a device state checking unit 1640, a level selecting unit 1645, and/or a stroke container generating unit 1650. The bounding box generating unit 1600, the box area calculating unit 1605, the transform extracting unit 1610, the cacheable detecting unit 1615, the bounding box checking unit 1620, the stroke size checking unit 1625, the render cost checking unit 1630, the stroke container cluster unit 1635, the device state checking unit 1640, the level selecting unit 1645, and/or the stroke container generating unit 1650 may support a function of processing a stroke via an algorithm stored in memory 220. According to an embodiment, the bounding box generating unit 1600, the box area calculating unit 1605, the transform extracting unit 1610, the cacheable detecting unit 1615, the bounding box checking unit 1620, the stroke size checking unit 1625, the render cost checking unit 1630, the stroke container cluster unit 1635, the device state checking unit 1640, the level selecting unit 1645, and/or the stroke container generating unit 1650 may be implemented as a hardware, a software or a combination of an hardware and a software.

According to an embodiment, the box area calculating unit 1605 of the bounding box generating unit 1600 may surround a stroke and identify an oriented bounding box rotated with respect to a base axis of a display 230, using points included in the stroke. The box area calculating unit 1605 may analyze a vertex list of the stroke to identify the oriented bounding box. The box area calculating unit 1605 may perform the operation 320 of FIG. 3.

According to an embodiment, the transform extracting unit 1610 of the bounding box generating unit 1600 may identify location information of the bounding box (or transform information of the bounding box area). The location information of the bounding box may include a coordinate (e.g., a center position) of a center point of the bounding box and orientation (or rotation) of the bounding box. The location information of the bounding box may be used to restore an image obtained using the bounding box (or an image cropped by the bounding box) to an original state. The transform extracting unit 1610 may perform the operation 320 of FIG. 3.

According to an embodiment, the cacheable detecting unit 1615 may determine whether the image obtained using the bounding box is cacheable. The cacheable detecting unit 1615 may perform the operation 610 of FIG. 6. The bounding box checking unit 1620 of the cacheable detecting unit 1615 may identify a size of the bounding box and compare the size of the bounding box and a threshold size. The bounding box checking unit 1620 may determine whether the image is cacheable by comparing the size of the bounding box with the threshold size. The bounding box checking unit 1620 may perform the operation 810 of FIG. 8.

According to an embodiment, the stroke size checking unit 1625 of the cacheable detecting unit 1615 may identify the number of points included in the stroke and compare the number of points included in the stroke with a first threshold number and/or a second threshold number. The stroke size checking unit 1625 may determine whether the image is cacheable by comparing the number of points included in the stroke with the first threshold number and/or the second threshold number. The stroke size checking unit 1625 may perform the operation 710 of FIG. 7 and the operation 730 of FIG. 7.

According to an embodiment, the render cost checking unit 1630 of the cacheable detecting unit 1615 may identify computation amount required for rendering the stroke and compare the computation amount with threshold computation amount. The render cost checking unit 1630 may determine whether the image is cacheable by comparing the calculation amount with the threshold calculation amount. The render cost checking unit 1630 may perform the operation 830 of FIG. 8.

According to an embodiment, the device state checking unit 1640 of the stroke container cluster unit 1635 may determine whether an image is cacheable with respect to a state of the electronic device 200. The device state checking unit 1640 may determine whether cached images (or files) with respect to the state of the electronic device 200 are mergeable. The device state checking unit 1640 may identify a load state of a graphic processing unit (GPU), a state of volatile memory (e.g., RAM or a GPU memory buffer), and/or a state of a program (or application) being executed. The device state checking unit 1640 may identify decoding time except for time required to render the stroke. The device state checking unit 1640 may identify remaining time (e.g., valid render time) until an editing feature (e.g., effect and/or animation) is displayed. The stroke container cluster unit 1635 may analyze remaining time for the stroke rendering to be completed. The remaining time for the stroke rendering to be completed may have real-time performance, and may include time excluding the decoding time and frame color converting time. The device state checking unit 1640 may adjust an amount of usage of the memory 220 to render the stroke. The device state checking unit 1640 may determine whether the image is cacheable with respect to the state of the electronic device 200 in the operation 610 of FIG. 6, and determine whether the cached images with respect to the state of the electronic device 200 in the operation 1130 of FIG. 11 are mergeable.

According to an embodiment, the level selecting unit 1645 of the stroke container cluster unit 1635 may classify a caching block (or a stroke container) according to a level based on information identified by the device state checking unit 1640. The level selecting unit 1645 may determine the number of images that may be cached for each level of the caching block (or the stroke container) and the number of caching blocks (or stroke containers) for each level. The level selecting unit 1645 may perform the operation 1120 of FIG. 11.

According to an embodiment, the stroke container generating unit 1650 of the stroke container cluster unit 1635 may generate the caching block (or the stroke container). The stroke container generating unit 1650 may generate the caching block (or the stroke container) of level 1 to cache a stroke based on a user input. The stroke container generating unit 1650 may identify whether the caching blocks (or the stroke containers) of level 1 are mergeable based on the number of the caching blocks (or the stroke containers) of level 1 reaching a threshold value. The stroke container generating unit 1650 may generate the caching block (or the stroke container) of level 2 based on a determination that the caching blocks (or the stroke containers) of level 1 are mergeable. The stroke container generating unit 1650 may decompose the caching block (or the stroke container) of level 2 (or level 3) based on an input for removing the stroke. The stroke container generating unit 1650 may generate caching blocks (or stroke containers) of level 1 by decomposing the caching block (or the stroke container) of level 2 (or level 3). The stroke container generating unit 1650 may perform the operation 1140 of FIG. 11, the operation 1310 of FIG. 13, and the operation 1340 of FIG. 13.

FIG. 17 is a block diagram illustrating an electronic device 1701 in a network environment 1700 according to various embodiments.

Referring to FIG. 17, the electronic device 1701 in the network environment 1700 may communicate with an electronic device 1702 via a first network 1798 (e.g., a short-range wireless communication network), or at least one of an electronic device 1704 or a server 1708 via a second network 1799 (e.g., a long-range wireless communication network). According to an embodiment, the electronic device 1701 may communicate with the electronic device 1704 via the server 1708. According to an embodiment, the electronic device 1701 may include a processor 1720, memory 1730, an input module 1750, a sound output module 1755, a display module 1760, an audio module 1770, a sensor module 1776, an interface 1777, a connecting terminal 1778, a haptic module 1779, a camera module 1780, a power management module 1788, a battery 1789, a communication module 1790, a subscriber identification module(SIM) 1796, or an antenna module 1797. In some embodiments, at least one of the components (e.g., the connecting terminal 1778) may be omitted from the electronic device 1701, or one or more other components may be added in the electronic device 1701. In some embodiments, some of the components (e.g., the sensor module 1776, the camera module 1780, or the antenna module 1797) may be implemented as a single component (e.g., the display module 1760).

The processor 1720 may execute, for example, software (e.g., a program 1740) to control at least one other component (e.g., a hardware or software component) of the electronic device 1701 coupled with the processor 1720, and may perform various data processing or computation. According to an embodiment, as at least part of the data processing or computation, the processor 1720 may store a command or data received from another component (e.g., the sensor module 1776 or the communication module 1790) in volatile memory 1732, process the command or the data stored in the volatile memory 1732, and store resulting data in non-volatile memory 1734. According to an embodiment, the processor 1720 may include a main processor 1721 (e.g., a central processing unit (CPU) or an application processor (AP)), or an auxiliary processor 1723 (e.g., a graphics processing unit (GPU), a neural processing unit (NPU), an image signal processor (ISP), a sensor hub processor, or a communication processor (CP)) that is operable independently from, or in conjunction with, the main processor 1721. For example, when the electronic device 1701 includes the main processor 1721 and the auxiliary processor 1723, the auxiliary processor 1723 may be adapted to consume less power than the main processor 1721, or to be specific to a specified function. The auxiliary processor 1723 may be implemented as separate from, or as part of the main processor 1721.

The auxiliary processor 1723 may control at least some of functions or states related to at least one component (e.g., the display module 1760, the sensor module 1776, or the communication module 1790) among the components of the electronic device 1701, instead of the main processor 1721 while the main processor 1721 is in an inactive (e.g., sleep) state, or together with the main processor 1721 while the main processor 1721 is in an active state (e.g., executing an application). According to an embodiment, the auxiliary processor 1723 (e.g., an image signal processor or a communication processor) may be implemented as part of another component (e.g., the camera module 1780 or the communication module 1790) functionally related to the auxiliary processor 1723. According to an embodiment, the auxiliary processor 1723 (e.g., the neural processing unit) may include a hardware structure specified for artificial intelligence model processing. An artificial intelligence model may be generated by machine learning. Such learning may be performed, e.g., by the electronic device 1701 where the artificial intelligence is performed or via a separate server (e.g., the server 1708). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1730 may store various data used by at least one component (e.g., the processor 1720 or the sensor module 1776) of the electronic device 1701. The various data may include, for example, software (e.g., the program 1740) and input data or output data for a command related thereto. The memory 1730 may include the volatile memory 1732 or the non-volatile memory 1734.

The program 1740 may be stored in the memory 1730 as software, and may include, for example, an operating system (OS) 1742, middleware 1744, or an application 1746.

The input module 1750 may receive a command or data to be used by another component (e.g., the processor 1720) of the electronic device 1701, from the outside (e.g., a user) of the electronic device 1701. The input module 1750 may include, for example, a microphone, a mouse, a keyboard, a key (e.g., a button), or a digital pen (e.g., a stylus pen).

The sound output module 1755 may output sound signals to the outside of the electronic device 1701. The sound output module 1755 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1760 may visually provide information to the outside (e.g., a user) of the electronic device 1701. The display module 1760 may include, for example, a display, a hologram device, or a projector and control circuitry to control a corresponding one of the display, hologram device, and projector. According to an embodiment, the display module 1760 may include a touch sensor adapted to detect a touch, or a pressure sensor adapted to measure the intensity of force incurred by the touch.

The audio module 1770 may convert a sound into an electrical signal and vice versa. According to an embodiment, the audio module 1770 may obtain the sound via the input module 1750, or output the sound via the sound output module 1755 or a headphone of an external electronic device (e.g., an electronic device 1702) directly (e.g., wiredly) or wirelessly coupled with the electronic device 1701.

The sensor module 1776 may detect an operational state (e.g., power or temperature) of the electronic device 1701 or an environmental state (e.g., a state of a user) external to the electronic device 1701, and then generate an electrical signal or data value corresponding to the detected state. According to an embodiment, the sensor module 1776 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1777 may support one or more specified protocols to be used for the electronic device 1701 to be coupled with the external electronic device (e.g., the electronic device 1702) directly (e.g., wiredly) or wirelessly. According to an embodiment, the interface 1777 may include, for example, a high definition multimedia interface (HDMI), a universal serial bus (USB) interface, a secure digital (SD) card interface, or an audio interface.

A connecting terminal 1778 may include a connector via which the electronic device 1701 may be physically connected with the external electronic device (e.g., the electronic device 1702). According to an embodiment, the connecting terminal 1778 may include, for example, an HDMI connector, a USB connector, a SD card connector, or an audio connector (e.g., a headphone connector).

The haptic module 1779 may convert an electrical signal into a mechanical stimulus (e.g., a vibration or a movement) or electrical stimulus which may be recognized by a user via his tactile sensation or kinesthetic sensation. According to an embodiment, the haptic module 1779 may include, for example, a motor, a piezoelectric element, or an electric stimulator.

The camera module 1780 may capture a still image or moving images. According to an embodiment, the camera module 1780 may include one or more lenses, image sensors, image signal processors, or flashes.

The power management module 1788 may manage power supplied to the electronic device 1701. According to an embodiment, the power management module 1788 may be implemented as at least part of, for example, a power management integrated circuit (PMIC).

The battery 1789 may supply power to at least one component of the electronic device 1701. According to an embodiment, the battery 1789 may include, for example, a primary cell which is not rechargeable, a secondary cell which is rechargeable, or a fuel cell.

The communication module 1790 may support establishing a direct (e.g., wired) communication channel or a wireless communication channel between the electronic device 1701 and the external electronic device (e.g., the electronic device 1702, the electronic device 1704, or the server 1708) and performing communication via the established communication channel. The communication module 1790 may include one or more communication processors that are operable independently from the processor 1720 (e.g., the application processor (AP)) and supports a direct (e.g., wired) communication or a wireless communication. According to an embodiment, the communication module 1790 may include a wireless communication module 1792 (e.g., a cellular communication module, a short-range wireless communication module, or a global navigation satellite system (GNSS) communication module) or a wired communication module 1794 (e.g., a local area network (LAN) communication module or a power line communication (PLC) module). A corresponding one of these communication modules may communicate with the external electronic device via the first network 1798 (e.g., a short-range communication network, such as Bluetooth™, wireless-fidelity (Wi-Fi) direct, or infrared data association (IrDA)) or the second network 1799 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1792 may identify and authenticate the electronic device 1701 in a communication network, such as the first network 1798 or the second network 1799, using subscriber information (e.g., international mobile subscriber identity (IMSI)) stored in the subscriber identification module 1796.

The wireless communication module 1792 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1792 may support a high-frequency band (e.g., the mmWave band) to achieve, e.g., a high data transmission rate. The wireless communication module 1792 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1792 may support various requirements specified in the electronic device 1701, an external electronic device (e.g., the electronic device 1704), or a network system (e.g., the second network 1799). According to an embodiment, the wireless communication module 1792 may support a peak data rate (e.g., 20 Gbps or more) for implementing eMBB, loss coverage (e.g., 1764 dB or less) for implementing mMTC, or U-plane latency (e.g., 0.5 ms or less for each of downlink (DL) and uplink (UL), or a round trip of 17 ms or less) for implementing URLLC.

The antenna module 1797 may transmit or receive a signal or power to or from the outside (e.g., the external electronic device) of the electronic device 1701. According to an embodiment, the antenna module 1797 may include an antenna including a radiating element composed of a conductive material or a conductive pattern formed in or on a substrate (e.g., a printed circuit board (PCB)). According to an embodiment, the antenna module 1797 may include a plurality of antennas (e.g., array antennas). In such a case, at least one antenna appropriate for a communication scheme used in the communication network, such as the first network 1798 or the second network 1799, may be selected, for example, by the communication module 1790 (e.g., the wireless communication module 1792) from the plurality of antennas. The signal or the power may then be transmitted or received between the communication module 1790 and the external electronic device via the selected at least one antenna. According to an embodiment, another component (e.g., a radio frequency integrated circuit (RFIC)) other than the radiating element may be additionally formed as part of the antenna module 1797.

According to various embodiments, the antenna module 1797 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1701 and the external electronic device 1704 via the server 1708 coupled with the second network 1799. Each of the electronic devices 1702 or 1704 may be a device of a same type as, or a different type, from the electronic device 1701. According to an embodiment, all or some of operations to be executed at the electronic device 1701 may be executed at one or more of the external electronic devices 1702, 1704, or 1708. In an example case in which the electronic device 1701 should perform a function or a service automatically, or in response to a request from a user or another device, the electronic device 1701, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1701. The electronic device 1701 may provide the outcome, with or without further processing of the outcome, as at least part of a reply to the request. To that end, a cloud computing, distributed computing, mobile edge computing (MEC), or client-server computing technology may be used, for example. The electronic device 1701 may provide ultra low-latency services using, e.g., distributed computing or mobile edge computing. In another embodiment, the external electronic device 1704 may include an internet-of-things (IoT) device. The server 1708 may be an intelligent server using machine learning and/or a neural network. According to an embodiment, the external electronic device 1704 or the server 1708 may be included in the second network 1799. The electronic device 1701 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1740) including one or more instructions that are stored in a storage medium (e.g., internal memory 1736 or external memory 1738) that is readable by a machine (e.g., the electronic device 1701). For example, a processor (e.g., the processor 1720) of the machine (e.g., the electronic device 1701) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

The technical problems to be achieved in this document are not limited to those described above, and other technical problems not mentioned herein will be clearly understood by those having ordinary knowledge in the art to which the present disclosure belongs.

As described above, the electronic device (e.g., the electronic device 200 of FIG. 2) may comprise at least one processor (e.g., the at least one processor 210 of FIG. 2) comprising processing circuitry, a display (e.g., the display 230 of FIG. 2), and memory (e.g., the memory 220 of FIG. 2), storing one or more programs configured to be executed by the at least one processor individually or collectively, comprising one or more storage media. The one or more programs may include instructions to cause the electronic device to, based on a handwriting input received via the display, identify a stroke (e.g., the stroke 410 of FIG. 4) including a plurality of points. The one or more programs may include instructions to further cause the electronic device to, based on rendering the stroke, display, via the display, the stroke. The one or more programs may include instructions to further cause the electronic device to identify, using the plurality of points, a bounding box (e.g., the bounding box 505 of FIG. 5) surrounding the stroke and location information of the bounding box. The one or more programs may include instructions to cause the electronic device to, based on at least one of a number of the plurality of points, a size of the bounding box, and/or computation amount required for rendering the stroke, determine whether an image, obtained using the bounding box, is cacheable. The one or more programs may include instructions to cause the electronic device to, based on a determination that the image is cacheable, cache the image and the location information of the bounding box.

For example, the one or more programs may include instructions to cause the electronic device to identify, using the points, an eigen vector of the plurality of points and an eigen value of the plurality of points. The one or more programs may include instructions to cause the electronic device to identify, using the eigen vector and the eigen value, the bounding box rotated with respect to a basis axis of the display and the location information of the bounding box. The location information of the bounding box may include a coordinate of a center point of the bounding box and orientation of the bounding box.

For example, the one or more programs may include instructions to cause the electronic device to, based on a determination that the image is uncacheable, refrain from caching the image and the location information of the bounding box.

For example, the one or more programs may include instructions to cause the electronic device to, based on the number of the plurality of points being less than a first threshold number, determine that the image is uncacheable. The one or more programs may include instructions to cause the electronic device to, based on the number of the plurality of points being greater than another threshold number, determine that the image is cacheable.

For example, the one or more programs may include instructions to cause the electronic device to, based on the number of the plurality of points being greater than the threshold number and being less than the another threshold number, compare the size of the bounding box with a threshold size. The one or more programs may include instructions to cause the electronic device to, based on the size of the bounding box being less than the threshold size, determine the image is cacheable. The one or more programs may include instructions to cause the electronic device to, based on the size of the bounding box being greater than the threshold size, compare the computation amount with threshold computation amount.

For example, the one or more programs may include instructions to cause the electronic device to, based on the computation amount being greater than the threshold computation amount, determine the image is cacheable. The one or more programs may include instructions to cause the electronic device to, based on the computation amount being less than the threshold computation amount, determine the image is uncacheable.

For example, the one or more programs may include instructions to cause the electronic device to, based on a pen type of the stroke, render the stroke. The one or more programs may include instructions to cause the electronic device to, based on rendering the stroke, display, via the display, the stroke, and identify the computation amount required for rendering the stroke according to the pen type.

For example, the one or more programs may include instructions to cause the electronic device to, while the image and the location information of the bounding box is cached, identify that a number of cached images including the image reaches a threshold number. The one or more programs may include instructions to cause the electronic device to, based on identifying that the number of the cached images reaches the threshold number, determine whether the cached images are mergeable. The one or more programs may include instructions to cause the electronic device to, based on a determination that the cached images are mergeable, cache a file in which the cached images and location information of bounding boxes of the cached images are merged. The one or more programs may include instructions to cause the electronic device to, based on a determination that the cached images are unmergeable, refrain from merging the cached images and the location information of the bounding boxes of the cached images.

For example, the one or more programs may include instructions to cause the electronic device to, while caching the file in which the cached images and the location information of the bounding boxes of the cached images are merged, identify that a number of cached files including the file reaches another threshold number. Each of the cached files may include the cached images of the threshold number. The one or more programs may include instructions to cause the electronic device to, based on identifying that the number of the cached files reaches the another threshold number, determine whether the cached files are mergeable. The one or more programs may include instructions to cause the electronic device to, based on a determination the cached files are mergeable, cache a file in which the cached files are merged. The one or more programs may include instructions to cause the electronic device to, based on a determination the cached files are unmergeable, refrain from merging the files.

For example, the one or more programs may include instructions to cause the electronic device to, while caching the file in which the cached images and the location information of the bounding boxes of the cached images are merged, receive an input for removing the stroke via the display. The one or more programs may include instructions to cause the electronic device to, based on the input for removing the stroke, separate the cached file into the cached images and the location information of the bounding boxes of the cached images. The one or more programs may include instructions to cause the electronic device to determine whether each of remained images excluding the image among the cached images is cacheable.

For example, the one or more programs may include instructions to cause the electronic device to, while caching the image and the location information of the bounding box, receive, via the display, another handwriting input. The one or more programs may include instructions to cause the electronic device to, based on the another handwriting input, identify another stroke. The one or more programs may include instructions to cause the electronic device to, based on rendering the another stroke, concurrently display, via the display, the stroke and the another stroke. The one or more programs may include instructions to cause the electronic device to, based on an input for removing the another stroke received while the stroke and the another stroke are concurrently displayed, maintain displaying, using the cached image and the location information of the bounding box, the stroke, and cease displaying the another stroke.

For example, the one or more programs may include instructions to cause the electronic device to identify a state of the electronic device. The one or more programs may include instructions to cause the electronic device to, based on at least one of the number of the plurality of points, the size of the bounding box, and/or the computation amount required for rendering the stroke, determine whether the image, obtained using the bounding box, is cacheable with respect to the state of the electronic device.

As described above, the method may be executed in an electronic device comprising a display. The method may include, based on a handwriting input received via the display, identifying a stroke including a plurality of plurality of points. The method may include, based on rendering the stroke, displaying, via the display, the stroke. The method may include identifying, using the plurality of points, a bounding box surrounding the stroke and location information of the bounding box. The method may include, based on at least one of a number of the plurality of points, a size of the bounding box, and/or computation amount required for rendering the stroke, determining whether an image, obtained using the bounding box, is cacheable. The method may include, based on a determination that the image is cacheable, caching the image and the location information of the bounding box.

For example, the method may include identifying, using the plurality of points, an eigen vector of the plurality of points and an eigen value of the plurality of points. The method may include identifying, using the eigen vector and the eigen value, the bounding box rotated with respect to a basis axis of the display and the location information of the bounding box. The location information of the bounding box may include a coordinate of a center point of the bounding box and orientation of the bounding box.

For example, the method may include, based on a determination that the image is uncacheable, refraining from caching the image and the location information of the bounding box.

For example, the method may include, based on the number of the plurality of points being less than a threshold number, determining that the image is uncacheable. The method may include, based on the number of the plurality of points being greater than another threshold number, determining that the image is cacheable.

For example, the method may include, based on the number of the plurality of points being greater than the threshold number and being less than the another threshold number, comparing the size of the bounding box with threshold size. The method may include, based on the size of the bounding box being less than the threshold size, determining the image is cacheable. The method may include, based on the size of the bounding box being greater than the threshold size, comparing the computation amount with threshold computation amount.

For example, the method may include, based on the computation amount being greater than the threshold computation amount, determining the image is cacheable. The method may include, based on the computation amount being less than the threshold computation amount, determining the image is uncacheable.

For example, the method may include, based on a pen type of the stroke, rendering the stroke. The method may include, based on rendering the stroke, displaying, via the display, the stroke, and identifying the computation amount required for rendering the stroke according to the pen type.

For example, the method may include, while the image and the location information of the bounding box are cached, identifying that a number of cached images including the image reaches a threshold number. The method may include, based on identifying that the number of the cached images reaches the threshold number, determining whether the cached images are mergeable. The method may include, based on a determination that the cached images are mergeable, caching a file in which the cached images and location information of bounding boxes of the cached images are merged. The method may include, based on a determination that the cached images are unmergeable, refraining from merging the cached images and the location information of the bounding boxes of the cached images.

For example, the method may include, while caching the file in which the cached images and the location information of the bounding boxes of the cached images are merged, identifying that a number of cached files including the file reaches another threshold number. Each of the cached files may include the cached images of the threshold number. The method may include, based on identifying that the number of the cached files reaches the another threshold number, determining whether the cached files are mergeable. The method may include, based on a determination the cached files are mergeable, caching a file in which the cached files are merged. The method may include, based on a determination the cached files are unmergeable, refraining from merging the files.

For example, the method may include, while caching the file in which the cached images and the location information of the bounding boxes of the cached images are merged, receiving an input for removing the stroke via the display. The method may include, based on the input for removing the stroke, separating the cached file into the cached images and the location information of the bounding boxes of the cached images. The method may include determining whether each of remained images excluding the image among the cached images is cacheable.

For example, the method may include, while caching the image and the location information of the bounding box, receiving, via the display, another handwriting input. The method may include, based on the another handwriting input, identifying another stroke. The method may include, based on rendering the another stroke, concurrently displaying, via the display, the stroke and the another stroke. The method may include, based on an input for removing the another stroke received while the stroke and the another stroke are concurrently displayed, maintaining displaying, using the cached image and the location information of the bounding box, the stroke, and ceasing displaying the another stroke.

For example, the method may include identifying a state of the electronic device. The method may include, based on at least one of the number of the plurality of points, the size of the bounding box, and/or the computation amount required for rendering the stroke, determining whether the image, obtained using the bounding box, is cacheable with respect to the state of the electronic device.

As described above, the non-transitory computer-readable storage medium may store one or more programs. The one or more programs, when executed by an electronic device including a display, may include instructions to cause the electronic device to, based on a handwriting input received via the display, identify a stroke including a plurality of plurality of points. The one or more programs, when executed by the electronic device, may include instructions to cause the electronic device to, based on rendering the stroke, display, via the display, the stroke. The one or more programs, when executed by the electronic device, may include instructions to cause the electronic device to identify, using the plurality of points, a bounding box surrounding the stroke and location information of the bounding box. The one or more programs, when executed by the electronic device, may include instructions to cause the electronic device to, based on at least one of a number of the plurality of points, a size of the bounding box, and/or computation amount required for rendering the stroke, determine whether an image, obtained using the bounding box, is cacheable. The one or more programs, when executed by the electronic device, may include instructions to cause the electronic device to, based on a determination that the image is cacheable, cache the image and the location information of the bounding box.

For example, the one or more programs, when executed by the electronic device, may include instructions to cause the electronic device to identify, using the plurality of points, an eigen vector of the plurality of points and an eigen value of the plurality of points. The one or more programs, when executed by the electronic device, may include instructions to cause the electronic device to identify, using the eigen vector and the eigen value, the bounding box rotated with respect to a basis axis of the display and the location information of the bounding box. The location information of the bounding box may include a coordinate of a center point of the bounding box and orientation of the bounding box.

For example, the one or more programs, when executed by the electronic device, may include instructions to cause the electronic device to, based on a determination that the image is uncacheable, refrain from caching the image and the location information of the bounding box.

For example, the one or more programs, when executed by the electronic device, may include instructions to cause the electronic device to, based on the number of the plurality of points being less than a threshold number, determine that the image is uncacheable. The one or more programs, when executed by the electronic device, may include instructions to cause the electronic device to, based on the number of the plurality of points being greater than another threshold number, determine that the image is cacheable.

For example, the one or more programs, when executed by the electronic device, may include instructions to cause the electronic device to, based on the number of the plurality of points being greater than the threshold number and being less than the another threshold number, compare the size of the bounding box with threshold size. The one or more programs, when executed by the electronic device, may include instructions to cause the electronic device to, based on the size of the bounding box being less than the threshold size, determine the image is cacheable. The one or more programs, when executed by the electronic device, may include instructions to cause the electronic device to, based on the size of the bounding box being greater than the threshold size, compare the computation amount with threshold computation amount.

For example, the one or more programs, when executed by the electronic device, may include instructions to cause the electronic device to, based on the computation amount being greater than the threshold computation amount, determine the image is cacheable. The one or more programs, when executed by the electronic device, may include instructions to cause the electronic device to, based on the computation amount being less than the threshold computation amount, determine the image is uncacheable.

For example, the one or more programs, when executed by the electronic device, may include instructions to cause the electronic device to, based on a pen type of the stroke, render the stroke. The one or more programs, when executed by the electronic device, may include instructions to cause the electronic device to, based on rendering the stroke, display, via the display, the stroke, and identify the computation amount required for rendering the stroke according to the pen type.

For example, the one or more programs, when executed by the electronic device, may include instructions to cause the electronic device to, while the image and the location information of the bounding box are cached, identify that a number of cached images including the image reaches a threshold number. The one or more programs, when executed by the electronic device, may include instructions to cause the electronic device to, based on identifying that the number of the cached images reaches the threshold number, determine whether the cached images are mergeable. The one or more programs, when executed by the electronic device, may include instructions to cause the electronic device to, based on a determination that the cached images are mergeable, cache a file in which the cached images and location information of bounding boxes of the cached images are merged. The one or more programs, when executed by the electronic device, may include instructions to cause the electronic device to, based on a determination that the cached images are unmergeable, refrain from merging the cached images and the location information of the bounding boxes of the cached images.

For example, the one or more programs, when executed by the electronic device, may include instructions to cause the electronic device to, while caching the file in which the cached images and the location information of the bounding boxes of the cached images are merged, identify that a number of cached files including the file reaches another threshold number. Each of the cached files may include the cached images of the threshold number. The one or more programs, when executed by the electronic device, may include instructions to cause the electronic device to, based on identifying that the number of the cached files reaches the another threshold number, determine whether the cached files are mergeable. The one or more programs, when executed by the electronic device, may include instructions to cause the electronic device to, based on a determination that the cached files are mergeable, cache a file in which the cached files are merged. The one or more programs, when executed by the electronic device, may include instructions to cause the electronic device to, based on a determination that the cached files are unmergeable, refrain from merging the files.

For example, the one or more programs, when executed by the electronic device, may include instructions to cause the electronic device to, while caching the file in which the cached images and the location information of the bounding boxes of the cached images are merged, receive an input for removing the stroke via the display. The one or more programs, when executed by the electronic device, may include instructions to cause the electronic device to, based on the input for removing the stroke, separate the cached file into the cached images and the location information of the bounding boxes of the cached images. The one or more programs, when executed by the electronic device, may include instructions to cause the electronic device to determine whether each of remained images excluding the image among the cached images is cacheable.

For example, the one or more programs, when executed by the electronic device, may include instructions to cause the electronic device to, while caching the image and the location information of the bounding box, receive, via the display, another handwriting input. The one or more programs, when executed by the electronic device, may include instructions to cause the electronic device to, based on the another handwriting input, identify another stroke. The one or more programs, when executed by the electronic device, may include instructions to cause the electronic device to, based on rendering the another stroke, concurrently display, via the display, the stroke and the another stroke. The one or more programs, when executed by the electronic device, may include instructions to cause the electronic device to, based on an input for removing the another stroke received while the stroke and the another stroke are concurrently displayed, maintain displaying, using the cached image and the location information of the bounding box, the stroke, and cease displaying the another stroke.

For example, the one or more programs, when executed by the electronic device, may include instructions to cause the electronic device to identify a state of the electronic device. The one or more programs, when executed by the electronic device, may include instructions to cause the electronic device to, based on at least one of the number of the plurality of points, the size of the bounding box, and/or the computation amount required for rendering the stroke, determine whether the image, obtained using the bounding box, is cacheable with respect to the state of the electronic device.

The effects that may be obtained from the present disclosure are not limited to those described above, and any other effects not mentioned herein will be clearly understood by those having ordinary knowledge in the art to which the present disclosure belongs.

What is claimed is:

1. An electronic device comprising:
at least one processor comprising processing circuitry;
a display; and
memory, storing one or more programs configured to be executed by the at least one processor individually and/or collectively, comprising one or more storage media,
wherein the one or more programs include instructions to cause the electronic device to:
based on a handwriting input received via the display, identify a stroke including a plurality of points,
based on rendering the stroke, display, via the display, the stroke,
identify, using the plurality of points, a bounding box surrounding the stroke and location information of the bounding box,
based on at least one of a number of the plurality of points, a size of the bounding box, or computation amount required for rendering the stroke, determine whether an image, obtained using the bounding box, is cacheable, and
based on a determination that the image is cacheable, cache the image and the location information of the bounding box.

2. The electronic device of claim 1,
wherein the one or more programs include instructions to cause the electronic device to:
identify, using the plurality of points, an eigen vector of the plurality of points and an eigen value of the plurality of points,
identify, based on the eigen vector and the eigen value, the bounding box rotated to a basis axis of the display and the location information of the bounding box,
wherein the location information of the bounding box comprises a coordinate of a center point of the bounding box and orientation of the bounding box.

3. The electronic device of claim 1,
wherein the one or more programs include instructions to cause the electronic device to:
based on a determination that the image is uncacheable, refrain from caching the image and the location information of the bounding box.

4. The electronic device of claim 3,
wherein the one or more programs include instructions to cause the electronic device to:
based on the number of the plurality of points being less than a first reference number, determine that the image is uncacheable, and
based on the number of the plurality of points greater than a second reference number, determine that the image is cacheable.

5. The electronic device of claim 4,
wherein the one or more programs include instructions to cause the electronic device to:
based on the number of the points greater than the first reference number and less than the second reference number, compare the size of the bounding box with a threshold size,
based on the size of the bounding box being less than the threshold size, determine the image is cacheable, and
based on the size of the bounding box greater than the threshold size, compare the computation amount with threshold computation amount.

6. The electronic device of claim 5,
wherein the one or more programs include instructions to cause the electronic device to:
based on the computation amount greater than the threshold computation amount, determine the image is cacheable, and
based on the computation amount less than the threshold computation amount, determine the image is uncacheable.

7. The electronic device of claim 1,
wherein the one or more programs include instructions to cause the electronic device to:
based on a pen type of the stroke, render the stroke, and
based on rendering the stroke, display, via the display, the stroke, and identify the computation amount required for rendering the stroke according to the pen type.

8. The electronic device of claim 1,
wherein the one or more programs include instructions to cause the electronic device to:
identify that a number of cached images including the image reaches a first threshold number,
based on identifying that the number of cached images reaches the first threshold number, determine whether the cached images are mergeable,
based on a determination that the cached images are mergeable, cache a file in which the cached images and location information of bounding boxes of the cached images are merged, and
based on a determination that the cached images are unmergeable, refrain from merging the cached images and the location information of the bounding boxes of the cached images.

9. The electronic device of claim 8,
wherein the one or more programs include instructions to cause the electronic device to:
identify that a number of cached files including the file reaches second threshold number, each of the cached files includes the cached images of the first threshold number,
based on identifying that the number of the cached files reaches the second reference number, determine whether the cached files is mergeable,
based on a determination the cached files are mergeable, cache a file in which the cached files are merged, and
based on a determination the cached files are unmergeable, refrain from merging the files.

10. The electronic device of claim 8,
wherein the one or more programs include instructions to cause the electronic device to:
while caching the file in which the cached images and the location information of the bounding boxes of the cached images are merged, receive an input for removing the stroke via the display,
based on the input for removing the stroke, separate the cached file into the cached images and the location information of the bounding boxes of the cached images, and
determine whether each of remained images excluding the image among the cached images are cacheable.

11. The electronic device of claim 1,
wherein the one or more programs include instructions to cause the electronic device to:
while caching the image and the location information of the bounding box, receive, via the display, another handwriting input,
based on the another handwriting input, identify another stroke,
based on rendering the another stroke, concurrently display, via the display, the stroke and the another stroke, and
based on an input for removing the another stroke received while the stroke and the another stroke are concurrently displayed, maintain displaying, using the cached image and the location information of the bounding box, the stroke, and cease displaying the another stroke.

12. The electronic device of claim 1,
wherein the one or more programs include instructions to cause the electronic device to:
identify a state of the electronic device, and
based on at least one of the number of the plurality of points, the size of the bounding box, and/or the computation amount required for rendering the stroke, determine whether the image, obtained using the bounding box, is cacheable with respect to the state of the electronic device.

13. A method executed in an electronic device comprising a display, the method comprising:
based on a handwriting input received via the display, identifying a stroke including a plurality of points,
based on rendering the stroke, displaying, via the display, the stroke,
identifying, using the plurality of points, a bounding box surrounding the stroke and location information of the bounding box,
based on at least one of a number of the plurality of points, a size of the bounding box, or computation amount required for rendering the stroke, determining whether an image, obtained using the bounding box, is cacheable, and
based on a determination that the image is cacheable, caching the image and the location information of the bounding box.

14. The method of claim 13, the method comprising:
identifying, using the plurality of points, an eigen vector of the plurality of points and an eigen value of the plurality of points,
identifying, based on the eigen vector and the eigen value, the bounding box rotated to a basis axis of the display and the location information of the bounding box,
wherein the location information of the bounding box comprises a coordinate of a center point of the bounding box and orientation of the bounding box.

15. The method of claim 13, the method comprising:
based on a determination that the image is uncacheable, refraining from caching the image and the location information of the bounding box.

16. The method of claim 15, the method comprising:
based on the number of the plurality of points being less than a first reference number, determining that the image is uncacheable, and
based on the number of the plurality of points greater than a second reference number, determining that the image is cacheable.

17. The method of claim 16, the method comprising:
based on the number of the points greater than the first reference number and less than the second reference number, comparing the size of the bounding box with threshold size,
based on the size of the bounding box being less than the threshold size, determining the image is cacheable, and
based on the size of the bounding box greater than the threshold size, comparing the computation amount with threshold computation amount.

18. The method of claim 17, the method comprising:
based on the computation amount greater than the threshold computation amount, determining the image is cacheable, and
based on the computation amount less than the threshold computation amount, determining the image is uncacheable.

19. The method of claim 13, the method comprising:
based on a pen type of the stroke, rendering the stroke, and
based on rendering the stroke, displaying, via the display, the stroke, and identifying the computation amount required for rendering the stroke according to the pen type.

20. The method of claim 13, the method comprising:
identifying that a number of cached images including the image reaches a first threshold number,
based on identifying that the number of cached images reaches the first threshold number, determining whether the cached images is mergeable,
based on a determination that the cached images are mergeable, caching a file in which the cached images and location information of bounding boxes of the cached images are merged, and
based on a determination that the cached images are unmergeable, refraining from merging the cached images and the location information of the bounding boxes of the cached images.
